(19) United States
(12) Patent Application Publication
(10) Pub. No.: US 2026/0127621 A1
(43) Pub. Date: May 7, 2026

(54) SYSTEMS AND METHODS FOR VERIFICATION

(71) Applicant: For Safety Group, Inc., Phoenix, AZ (US)

(72) Inventors: Niclas Braun, Ubstadt-Weiher (DE); Julian Wiebke, Dreieich (DE)

(73) Assignee: For Safety Group, Inc., Phoenix, AZ (US)

(21) Appl. No.: 18/970,761

(22) Filed: Dec. 5, 2024

Related U.S. Application Data
(63) Continuation of application No. 18/970,652, filed on Dec. 5, 2024, now abandoned.
(60) Provisional application No. 63/717,623, filed on Nov. 7, 2024.

(51) Int. Cl. G06Q 30/018

(52) U.S. Cl. CPC G06Q 30/018

(57) ABSTRACT

Systems and methods for verification and authentication of digital and physical objects are described. The system performs the method of receiving a verification tag request, generating, a verification tag in response to the verification tag request, receiving a verification request comprising the verification tag, determining a verification notification based on the verification request; and transmitting the verification notification to a graphical user interface of a client network device.

### CROSS-REFERENCE TO RELATED APPLICATIONS

This application is a continuation of, and claims priority to and the benefit of, U.S. patent application Ser. No. 18/970,652, filed Dec. 5, 2024 and entitled “SYSTEMS AND METHODS FOR VERIFICATION,” which is a non-provisional of, and claims priority to and the benefit of, U.S. Provisional Patent Application No. 63/717,623, filed Nov. 7, 2024 and entitled “SYSTEMS AND METHODS FOR VERIFICATION,” which is hereby incorporated by reference herein in its entirety for all purposes.

### FIELD

This disclosure generally relates to systems and methods for verification of people, online content, and physical objects.

### BACKGROUND

In the digital age, the consumption and sharing of multimedia content (e.g., photographs, audio files, video files, documents and text files)—has become ubiquitous. Social media platforms, news outlets, and various online marketplaces facilitate the rapid dissemination of information and media, often without sufficient verification mechanisms. With the rise of user-generated content, there has been a significant increase in anonymity associated with postings, often making it difficult to authenticate the origin or legitimacy of digital files. This challenge is compounded by the increasing sophistication of digital manipulation techniques, such as deepfakes and photoshopped images, which can deceive viewers and spread misinformation on a global scale. Additionally, fraudulent data manipulation can be implemented on corporate statements and spreadsheets that can result in market manipulation.

Similarly, the rise of e-commerce and online trading platforms has brought with it the proliferation of physical goods that require verification of authenticity. Collectors of items such as sports memorabilia, luxury goods, and even pharmaceutical products (e.g., vaccines) are increasingly concerned about the risk of counterfeits, particularly because some of the items may be very valuable. Unscrupulous actors can take advantage of anonymity and the lack of secure verification processes, creating a growing market for fake items that resemble legitimate products. Further, these bad actors may provide fake goods under a false identity to further conceal their actions. A sufficient digital human identification method does not currently exist. The need for an effective system to verify digital documents, physical objects and/or human identification is paramount for both consumer protection and market integrity. Additionally, no existing system exists for tying a person's verified human identity to digital and physical assets, which would increase security and trust amongst consumers.

Currently, there is no unified method for verifying the authenticity of digital multimedia content, physical objects, and/or human identity in a decentralized and anonymous online environment, or in an offline environment. While individual solutions may exist (e.g., digital watermarks for photos, certificates of authenticity for physical goods, physical seals etc.), these methods are often siloed, limited in scope, and susceptible to forgery or tampering. Moreover, traditional verification methods can be slow or expensive, which undermines the efficiency and scalability that should be part of today's fast-paced, digitally driven economy. Further, images, documents, audio clips and videos created by artificial intelligence are becoming increasingly realistic and harder to discern if the images and videos are authentic.

A system and method for online verification that covers multimedia content (e.g., photos, audio files, video files, text files, documents), physical objects, and/or human identity is crucial in addressing these issues. Such a system would enable real-time, decentralized verification processes, fostering trust and transparency in digital and physical transactions. The increasing sophistication of forgery and the widespread anonymity of online actors highlight the pressing need for a solution that can both deter fraudulent behavior and provide peace of mind for users and consumers alike.

### SUMMARY

In various embodiments, the method may comprise receiving, by one or more processors, an object submission from a first network device comprising an object, and generating, by the one or more processors, a verification tag associated with the object. The object can be a digital object, such as, for example, a video, a text file, a multimedia image, an audio file, and a document, or other digital objects. The object can be a physical object, such as medical equipment, vaccines, memorabilia, among other physical objects. In various embodiments, the method may comprise generating, by the one or more processors, a verification tag associated with the object. The verification tag may be assigned to the object, and it may comprise a latitude, a longitude, an altitude, a time, and a unique number. The method may comprise receiving, by one or more processors, a verification request from a second network device, the verification request comprising a search tag. In various embodiments, the method further comprises verifying, by the one or more processors, the verification request by comparing the search tag and the verification tag. The method may comprise transmitting, by the one or more processors, a verification notification to a graphical user interface of the second network device in response to the verification request.

In various embodiments, the system may comprise one or more processors and one or more tangible, non-transitory memories configured to communicate with the one or more processors. In various embodiments, the one or more tangible, non-transitory memories have instructions stored thereon that, in response to execution by the one or more processors, cause the one or more processors to perform operations. The operations may include any steps of the method. In various embodiments, the system may comprise an application server, blockchain network, and a network device, all in communication with a network.

In various embodiments, the method may comprise scanning, by a registration device, a chaotic structure of a material, recording, by the registration device, chaotic structure data from a scan of the chaotic structure of the material, and transmitting, by the registration device, the chaotic structure data and the object data associated with the chaotic structure data for recording on an application server. In various embodiments, the method may comprise transmitting, by a verification device, the chaotic structure data to be verified by the application server, receiving, by the verification device, the object data associated with the chaotic structure data from the application server, and displaying, by the verification device, the object data associated with the chaotic structure data on a display of the verification device. The object data associated with the chaotic structure data may comprise a place of origin, an owner, a latitude, and a longitude. In various embodiments, the registration device comprises a scanner configured to read the chaotic structure of the material and a display to record the object data associated with the chaotic structure. In various embodiments, the method may comprise receiving, by an application server, a chaotic structure data and object data associated with a chaotic structure, and recording, by the application server, the chaotic structure data and the object data associated with the chaotic structure in an object database. In various embodiments, the method comprises transmitting, by the application server, the object data associated with the chaotic structure to a verification device. In various embodiments, the verification device can be any type of terminal (e.g., kiosk).

In various embodiments, the system may comprise one or more processors and one or more tangible, non-transitory memories configured to communicate with the one or more processors. In various embodiments, the one or more tangible, non-transitory memories have instructions stored thereon that, in response to execution by the one or more processors, cause the one or more processors to perform operations. The operations may include any steps of the method. In various embodiments, the system may comprise an application server and a registration device. In various embodiments, the registration device comprises a display. In various embodiments, the registration device comprises a printer configured to print a chaotic structure on a material. In various embodiments, the system may comprise the application server and a verification device. The verification device may comprise a display and a scanner. In various embodiments, the system comprises the application server, the registration device and the verification device.

In various embodiments, a human verification device is disclosed. The human verification device can comprise a housing, a glass disposed within the housing, a material directly beneath the glass and disposed within the housing, a battery disposed in the housing and a biometric scanner disposed on an exterior of the housing. In various embodiments, the glass can be controlled to change from opaque to transparent when activated, and in some cases the glass is an electrochromic glass. In various embodiments, the material is a three-dimensional chaotic structure (e.g, ChaosLayer Technology from For Safety Group, Inc.). In various embodiments, the biometric scanner is a fingerprint reader. In various embodiments, the human verification device comprises a wearable strap (e.g., a wrist strap, a necklace, a phone case or a wallet).

In various embodiments, the method may comprise scanning, by a verification device, a chaotic structure of a material disposed in a human verification device, transmitting, by the verification device, the chaotic structure data to be verified by the application server, receiving, by the verification device, a personal data associated with the chaotic structure data from the application server, and displaying, by the verification device, the personal data associated with the chaotic structure data on a display of the verification device. In various embodiments, the personal data associated with the chaotic structure data comprises a name, a personal photo, and at least one of a method of payment, a passport, a driver's license, and an ownership ledger. The chaotic structure data can further comprise a know your customer verification associated with any demographic information or identification document (e.g., name, driver's license and/or passport).

In various embodiments, the system may comprise one or more processors and one or more tangible, non-transitory memories configured to communicate with the one or more processors. In various embodiments, the one or more tangible, non-transitory memories have instructions stored thereon that, in response to execution by the one or more processors, cause the one or more processors to perform operations. The operations may include any steps of the method. In various embodiments, the system may comprise an application server, a verification device, and a human verification device.

### BRIEF DESCRIPTION OF THE DRAWINGS

The subject matter of the present disclosure is particularly pointed out and distinctly claimed in the concluding portion of the specification. A more complete understanding of the present disclosures, however, may best be obtained by referring to the detailed description and claims when considered in connection with the drawing figures, wherein like numerals denote like elements.

FIG. 1 illustrates an exemplary system of a client network device, network and server, in accordance with various embodiments;

FIG. 2 illustrates an exemplary object management system, in accordance with various embodiments;

FIG. 3 illustrates an exemplary system with a blockchain network, in accordance with various embodiments;

FIG. 4 illustrates an exemplary method for verifying an object, in accordance with various embodiments;

FIG. 5 illustrates an exemplary system with a registration device, in accordance with various embodiments;

FIG. 6 illustrates an exemplary system with a verification device, in accordance with various embodiments;

FIG. 7 illustrates an exemplary reader device, in accordance with various embodiments;

FIGS. 8A and 8B illustrate exemplary currency reader devices, in accordance with various embodiments;

FIG. 9 illustrates an exemplary method for registering a physical object, in accordance with various embodiment;

FIG. 10 illustrates an exemplary method for verifying a physical object, in accordance with various embodiments;

FIGS. 11A and 11B illustrate exemplary human verification devices, in accordance with various embodiments;

FIG. 12 illustrates an exemplary wearable human verification device, in accordance with various embodiments;

FIGS. 13A and 13B illustrate an exemplary verification terminal, in accordance with various embodiments; and

FIGS. 14A and 14B illustrate an exemplary handheld reader device, in accordance with various embodiments.

### DETAILED DESCRIPTION

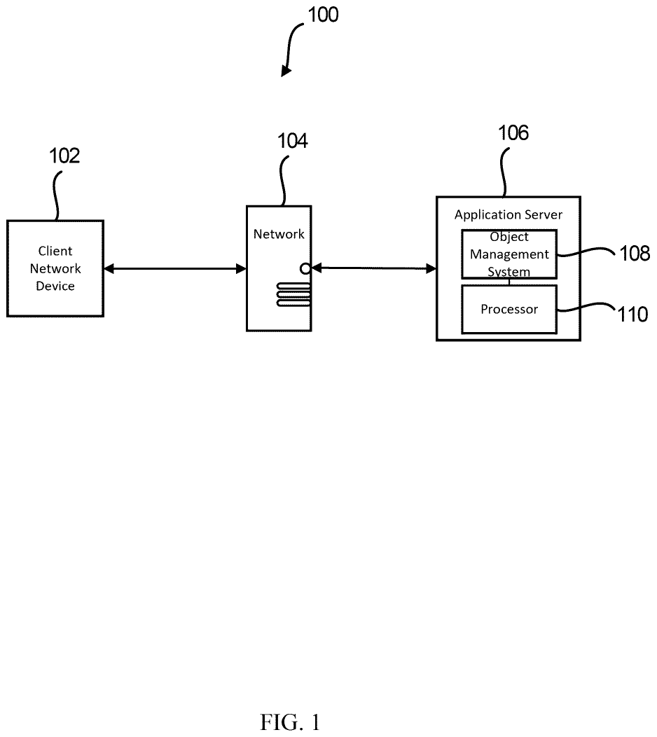

With reference to FIG. 1, a block diagram for a system 100 is illustrated, in accordance with various embodiments. The system 100 comprises a client network device 102 (e.g., personal network device) in communication with a network 104. As illustrated, there is one client network device 102, however, there can be any plurality of client network devices that are connected to the network, including a first client network device and a second client network device. The various components may communicate via wired and/or wireless transmission of data. Each of the components discussed herein may be one component or a plurality of components. The system 100 also comprises an application server 106 in communication with the network 104. The client network device 102 transmits data and commands over the network 104 to the application server 106. The application server 106 can transmit application data to the client network device 102 via the network 104. The application data can instruct the client network device 102 to open a user interface. The user interface can be a graphical user interface (GUI) which can allow a user to navigate objects and object data stored in an object management system 108 of the application server 106. The client network device 102 comprises at least one non-transitory computer-readable storage medium having executable computer program instructions embodied therein for processing and displaying a verification tag and verification requests, and objects of the object management system 108.

The application server 106 may comprise one or more processors 110, and the object management system 108. The processor 110 may include one or more logic devices such as one or more of a central processing unit (CPU), an accelerated processing unit (APU), a digital signal processor (DSP), a field programmable gate array (FPGA), an application specific integrated circuit (ASIC), or the like. In various embodiments, the processor 110 may further include any non-transitory memory known in the art. The object management system 108 may store instructions usable by the logic device to perform operations. Any appropriate computer-readable type/configuration may be utilized as the object management system 108, any appropriate data storage architecture may be utilized by the object management system 108, or both.

In various embodiments, the client network device 102 can access the application server 106 via the network 104 and transmit data from the client network device 102 to the application server 106. The data transmitted from the client network device 102 can comprise an object submission. In various embodiments, the object submission can only be transmitted to the application server 106 from the client network device 102, if the client network device 102 is a verified user. The verification process for making the client network device 102 a verified user can be a verification process such as Know Your Customer/Client (KYC) or Know Your Business (KYB) or any other user verification method known in the art. The object submission can comprise the object and all object associated data, as further defined below.

In various embodiments, a search tag can be transmitted from the client network device 102 to the application server 106, without the client network device 102 being a verified user. This process of transmitting the search tag is done on an open display page of the GUI, while in contrast a locked display page only accessed by verified users is used to transmit object submissions. This allows an unverified user, who is not transmitting object submissions, to still have the ability to verify objects within the system 100 via a verification request.

In various embodiments, verified users may login to a secure portal before accessing the application server 106. The secure portal may receive, for example, a registered username and a password, authenticate the user, then associate the system with the verified user to enable use by the verified user. In various embodiments, the secure portal may receive, for example, a scan of a safety key associated with the verified user. In various embodiments, the authentication user process is completed using KYC, and after the user has been authenticated, the verified user can open an organization profile for a business and verify the organization profile using KYB. The organization can invite other verified users to post and upload digital objects to the organization's profile. Login pages originating at a web client may be verified by a firewall, in order to prevent unauthorized access from unverified users. Encryption may be performed by way of any of the techniques now available in the art or which may become available—e.g., Twofish, RSA, El Gamal, Schorr signature, DSA, PGP, PKI, GPG (GnuPG), HPE Format-Preserving Encryption (FPE), Voltage, Triple DES, Blowfish, AES, MD5, HMAC, IDEA, RC6, and symmetric and asymmetric cryptosystems. The systems and methods may also incorporate SHA series cryptographic methods, elliptic curve cryptography (e.g., ECC, ECDH, ECDSA, etc.), and/or other post-quantum cryptography algorithms under development.

The firewall may include any hardware and/or software suitably configured to protect CMS components and/or enterprise computing resources from unverified users. Further, a firewall may be configured to limit or restrict access to various systems and components behind the firewall for web clients connecting through a web server. Firewall may reside in varying configurations including Stateful Inspection, Proxy based, access control lists, and Packet Filtering among others. Firewall may be integrated within a web server or any other CMS components or may further reside as a separate entity. A firewall may implement network address translation (“NAT”) and/or network address port translation (“NAPT”). A firewall may accommodate various tunneling protocols to facilitate secure communications, such as those used in virtual private networking. A firewall may implement a demilitarized zone (“DMZ”) to facilitate communications with a public network such as the internet. A firewall may be integrated as software within an internet server or any other application server components, reside within another computing device, or take the form of a standalone hardware component.

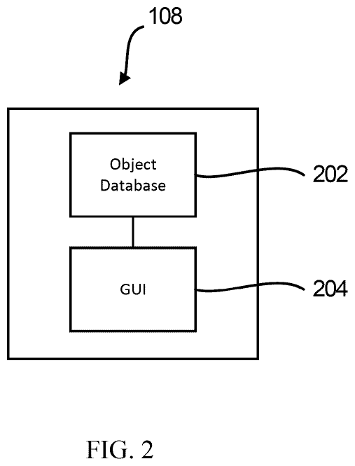

With reference to FIG. 2, the object management system 108 is illustrated in accordance with various embodiments. The object management system 108 comprises an object database 202 and a graphical user interface (GUI) 204. The object database 202 can be configured to store a plurality of objects that have been verified by the system 100 and object data associated with each of the plurality of objects. The object data can comprise an object file, an object submission location, an object submission timestamp, and a verification tag. In various embodiments, the objects can be digital objects such as a video, a photo, a written text, an audio, a document or any other digital object. In various embodiments, the objects can be physical objects such as medical equipment, a vaccine, a memorabilia, or any other physical object that could benefit from verification. In various embodiments, a watermark may be added to the object file that is transmitted to the object database 202. The watermark may include the verification tag. In various embodiments, the verification tag may be referred to as a safety stamp. Such a safety stamp may include location data and/or time data. In some embodiments, humans can be verified and their personal data associated with a safety stamp.

In various embodiments, the object file for the video can be a video file and/or a screenshot of the video, the object file for the photo can be a photo file, the object file for the written text can be a text file, the object file for the physical objects can be a captured image of the physical objects and a chaotic structure. In various embodiments, the object submission location is the location of the client network device 102 when the object submission is initiated, including a latitude, a longitude and an altitude of the client network device 102. In various embodiments, the latitude, longitude and altitude of the client network device 102 is derived from a web browser's geolocation plugin from the client network device's 102 (e.g., Google Chrome, Microsoft Edge, Mozilla FireFox, etc.). In various embodiments, the latitude, longitude and altitude of the client network device 102 may be derived from the client network device 102 through cellular or wifi location tracking. In various embodiments, the object submission timestamp is a time at which the client network device 102 completed the object submission. In some embodiments, the time is an integer including seconds. For example, if the object submission is at exactly Noon on Oct. 1, 2024, the timestamp may include 20241001120000. Further, in response to the object submission, the object management system 108 generates and assigns a verification tag to the object. In various embodiments, the verification tag can comprise the latitude, the longitude, the altitude, the time, and a unique number, and those numbers can be placed in that order or any other suitable order. If a user decides not to disclose the client network device's 102 geolocation with the application server 106, then the fields for the latitude, the longitude and the altitude may comprise only zeros. The unique number can comprise one digit to nine digits, and it may be randomly generated using known random number generating methods. As such, the verification tag may be a unique verification tag that includes a unique number. The intent of the unique number is to prevent multiple users from having the same numbers as part of the verification tag, when transmitting object submissions from the same location at the same time.

In various embodiments, the object submission comprises responses to a list of queries transmitted by the application server 106 to the GUI 204. The list of queries may request an object publication status (e.g., is the object published or unpublished), a content sensitivity status (e.g., does the object comprise sensitive content), a rightsholder status (e.g., is the user submitting the object submission the rightsholder of the object), an AI-generated status (e.g., is the object created or generated by artificial intelligence). In various embodiments, if the content sensitivity status is true, then the object is initially blurred on the GUI 204. In various embodiments, the application server 106 can use artificial intelligence to analyze the object and make a determination whether the object comprises nudity or other sensitive content and determine, without user input, that the sensitivity status of the object is true. In various embodiments, the application server 106 can use artificial intelligence to analyze the object and make a determination whether the object is a duplicate of another object, or if the object is AI-generated, which in turn will output the AI-generated status as true. In various embodiments, if the object publication status is true (e.g., the object was previously published), then the user may transmit a URL with the object submission to the application server 106 and the URL will be available on the application server 106.

Further, in various embodiments, the objects created by verified users and sent through an object submission are stored in the object database 202. In various embodiments, the objects may each comprise a verification tag. The objects may also include a taxonomy classification tag that indexes the objects in the object management system. In various embodiments, the verification tag is associated with and/or linked to the fixed asset (e.g., object). In various embodiments, the taxonomy classification tag can be used to categorize the objects. The categorization may enhance searchability of the objects in the object management system. The enhanced searchability may improve user experience. The taxonomy classification tag can comprise themes, subjects, and/or characteristics of the object (e.g., a drawing, a song, a blueprint, a document, etc.). In various embodiments, the taxonomy classification tag is created by the user as part of the process for submitting the object to the system. The classification can help streamline the verification process by grouping similar objects together for verification. In various embodiments, the taxonomy classification tag is used to associate an object in a marketplace on the application server 106, and in response to the system retrieving objects from the marketplace based on a user search, the search results can use the taxonomy classification tag to present relevant search results.

Additionally, data about physical objects that go through the verification process can also be stored in the object database 202 with the taxonomy classification tag. In various embodiments, the application server 106 can comprise a marketplace. The marketplace can be a user interface that allows for verified users to buy and sell physical and digital objects securely. The taxonomy classification tag for physical objects can be based on a product (e.g., automobile, boat, produce, vaccine, art, alcohol, electronic devices, etc.). The taxonomy classification tag may also include a category (e.g., automobile manufacturer, boat manufacturer, vegetable, vaccine manufacturer, painting, whiskey, cell phones, etc.) of the physical object. The taxonomy classification tag may allow for easier searching and indexing of physical objects on the platform.

In various embodiments, the objects and their associated object data can be concurrently stored on a blockchain network for an additional layer of security and authentication. The objects and their associated object data can be stored using any form of data storage, data authentication, and data security, as described herein. In various embodiments, when the object file is uploaded to the system 100, and a verification method is completed (via method 400 described herein), a transaction is triggered on the blockchain. The transaction records all (or any subset of) an object file hash, the verification tag, and the object data associated with the object, to help ensure the authenticity and traceability of the object.

Additionally, the system 100 can conduct a verification request, wherein the system 100 queries the object database 202 with a search tag transmitted in the verification request to determine if an object's verification tag sufficiently matches the search tag. The search tag is a numerical string that the user uses to search and confirm if the object is a verified object. For example, a user on the client network device 102 can search the object database 202 by transmitting the search tag to the application server 106. In various embodiments, the system can use a retrieval-augmented generation process to search the object database 202 to find any objects comprising a verification tag that matches the search tag. If the system 100 does not find a verification tag that matches the search tag, then the GUI 204 outputs that the object is not verified. If the system 100 finds a verification tag that matches the search tag, then the system verifies the object by instructing the processor 110 to access the object data of the matching verification tag, and the GUI 204 displays the object data associated with the found object on the client network device 102. The object and the object data associated with the object may be stored in the object database 202 and may be accessed by the processor 110 and displayed by the GUI 204. The GUI 204 is transmitted to the client network device 102 by the application server 106 via the network 104.

For example, a video creator can create a video for a web-based video platform. The video creator can use their client network device 102, with the video stored thereon and the client network device being a verified user by previously going through the verification process. Prior to uploading the video to the web-based video platform, the client network device transmits an object submission comprising the video to the application server 106. The application server 106 generates a verification tag for the video and transmits the verification tag to the video creator on a GUI of the client network device 102. The application server 106 also stores the video and the object data associated with the video in the object management system 108. Once the video creator has the verification tag for the video, the video creator can post their video to the web-based video platform and display the verification tag for viewers of the video to sec. The verification tag can be displayed in the text underneath a post on the web-based video platform. The verification tag can be embedded in the description of the video. The verification tag may be embedded with a hyperlink to send to a viewer who can select the hyperlink to start the process to verify the video. The user may have the option to click (e.g., right-click) to select an option to initiate the verification of the verification tag.

If a viewer on a client network device 102 wanted to verify that the video was from the video creator, then the viewer can use the client network device 102 to transmit a verification request to the application server 106. The verification request would comprise a search tag, which in this case is the video creator's verification tag that the creator associated with the video or posted alongside the video. The object management system 108 runs a search to confirm that a verification tag matches the search tag. The application server 106 then transmits a verification notification to a GUI of the client network device 102. The verification notification comprises the object and object associated data, such as the object submission location and the object submission timestamp. In various embodiments, verified personal information (e.g., a username and/or a legal name) of the verified user who creates the object submission can be transmitted with the verification notification. In various embodiments, the verified personal information of the verified user who creates the object submission is hidden from public or anonymized. In some circumstances, the search tag does not match any verification tag stored in the object management system 108, in that case the verification notification includes an unverified statement. The unverified statement can comprise written text that states that the search tag is not associated with a verification tag and cannot be verified.

In various embodiments, the system 100 can conduct the verification request by querying the object database 202 with a search file (comprised of any of the objects) transmitted in the verification request and to determine if an object stored in the object database 202 matches the search file. The search file is a file uploaded that the user wants to search and confirm if it is an object that has been verified and is stored in the object database 202, or if any changes have been made to the search file. For example, a user on the client network device 102 can search the object database 202 by transmitting the search file to the application server 106. In various embodiments, the system can use a retrieval-augmented generation process to search the object database 202 to find any objects that match the search file. The match between the search file and the objects can have a confidence level (e.g., between 1%-100%). If an object has a match within a certain the confidence level, then the GUI 204 outputs any objects with a match and a match confidence level. The confidence level is a numerical representation of how closely the search file matches an object stored in the object management system. This score is determined by several factors including, for example, the features extracted from the objects. The extracted features may include, for example, color, shape, and texture for images, keywords and/or metadata for documents.

Generally, an object file comprises data points embedded in a continuous space and in some cases the data points can be transitioned to vectors in a multi-dimensional space. Vectorization of data is known in the art and can be done through multiple types of vectorization processes, which are done on the application server when object data is transferred. In various embodiments, the vectorization for an object file that is an image file is done using a vision process (e.g., an Azure Computer Vision process). The vision process identifies and locates objects within the image file (e.g., people, animals, vehicles, etc.), automatically generates taxonomy tags for the image file based on the objects detected, which can assist in searching the application server for the object file. In various embodiments, if the object file is a document file, then the vision process utilizes an optical character recognition process to digitize the document into a readable and searchable image file. In various embodiments, the vision process converts the image file into a vector based on the data embedded in the image file. In various embodiments, the vision process can identify a scene of the image file (e.g., a beach, a city, a forest) and a spatial analysis of the image file (e.g., spatial relationship between objects in an image, which is useful for augmented and virtual reality.

In various embodiments, vectors are numerical representations of the data points, which allows for mathematical operations to be run that compare vectors from multiple object files and determine a confidence level (e.g., the confidence level discussed above) of the similarity between said multiple object files. In various embodiments, the confidence level is calculated using a function, and in some instances the function is a sigmoid function. In various embodiments, the vectors are compared using a cosine similarity function. The cosine similarity function can compare a vector of a first object file to a vector of a second object file by measuring the cosine of an angle between the vector of the first object file and the vector of the second object file. In various embodiments, the vectors are stored on the application server 106, and the vectors are stored as 32-bit floating-point numbers. In various embodiments, the vectors are stored as 32-bit floating-point numbers to help with processing of the vectors by the application server 106. In various embodiments, the vectors comprise the same dimensions (e.g., the dimension of each vector is 3072 dimensions), in order to assist with comparing vectors of the same size. In various embodiments, the vectors are indexed using a quantized flat index type in order to efficiently store and query high-dimensional vectors.

In various embodiments, the vectors are stored using a vector database (e.g., Azure Cosmos DB), which is a globally distributed, multi-model database service designed to provide high availability, low latency, and scalability of the vectors. The vector database supports various data models, including documents, key-value, graph and column-family.

In various embodiments, the GUI 204 can display the search file and any matching objects side-by-side for visual comparison by the user. In various embodiments, there can be a compare output that highlights the differences, if any, between the search file and any objects with the match. In various embodiments, if the search file is an image file, then the matched objects can be side-by-side with the search file. In various embodiments, the search file and the matched object can be layered on top of each other, and a scroll function can be utilized to peel back the object from the matched object (from the search file) to see the differences. The GUI 204 may be transmitted to the client network device 102 by the application server 106 via the network 104.

The object database 202 may be integral to the application server 106 or may be located physically remote from the application server 106. By locating the application server 106 and the object database 202 remote from each other, the object database 202 can more efficiently and effectively focus on the task of searching and providing object verification across the network 104 when requested. In this regard, the system may improve the functioning of the network 104 by accelerating network response times. The processor 110 may communicate with the object database 202 via any wired or wireless protocol. In that regard, the processor 110 may access data stored in the object database 202. Any number of conventional techniques for electronics configuration, signal processing and/or control, data processing and the like may be employed. Also, the processes, functions, and instructions may can include software routines in conjunction with processors, etc.

In various embodiments, the object is a physical object as discussed. Often times, medicine is counterfeited, and it can be hard to verify the source of production for medicine. The system 100 and associated methods disclosed herein can help solve this problem. For example, the object can be a bottle of medicine. A verified user can transmit an image of the bottle of medicine as the object at a place of production and receive a verification tag from the application server 106. The manufacturer can print the verification tag on the inside of the packaging for consumers to see when opening the medicine. The verification tag can also be printed on a card, which may accompany the product and the card can further comprise a safety layer. Patients/doctors who later have possession of the medicine can submit a verification request with the verification tag and gather all of the object data for that specific bottle of medicine.

In another embodiment, the object can include a third-party verification confirming the object as true from a third-party's perspective. For example, a verified user wants to create a job resume that includes work experience that is already verified and does not require a prospective employer to do additional follow-up to the verified user's former places of work. In this case, the verified user can transmit a verification tag by third-party object submission. In this case, the verification tag comprises an object and object data, as discussed herein, and also comprises a third-party request. In this example, the verified user's object is a written description of their former occupation and how long they worked with their former employer (third-party). The third-party request may be a verification communication to the former employer requesting the third-party verification of the verified user's written description. The verification communication may be, for example, an email, SMS, or internal notification within the platform, which can be verified and authenticated with a safety key. In various embodiments, the third-party is a verified organization that has undergone KYB verification. The verified organization receives the third-party request. A verified user of the verified organization can submit a response to the verification communication. Once an affirmative response to the verification communication is received, then a verification tag can be assigned to the object. The third-party verification is also stored with the object data and can be displayed on the GUI of a network device. Another example can include third-party verification of written text by publications (such as New York Times, TIME Magazine, etc.) that publish the written text. This allows for streamlined processes where customers looking at verified information can trust the source of the information, without having to expend time and resources to do the verification themselves.

In yet a further embodiment, the client network device 102 can comprise a video camera and/or a microphone to capture digital multimedia (i.e., video and audio). When the client network device 102 is a verified user and in communication with the application server 106, the client network device 102 can record a live verified object. The live verified object is captured on the client network device 102, while in communication with the application server 106. The live verified object is automatically assigned a verification tag at the time of creation of the live verified object. In various embodiments, in response to the live verified object stopping being recorded, then the verification tag is created for the live verified object. The live verified object is stored in the object database 202 and can be exported to a memory of the client network device 102.

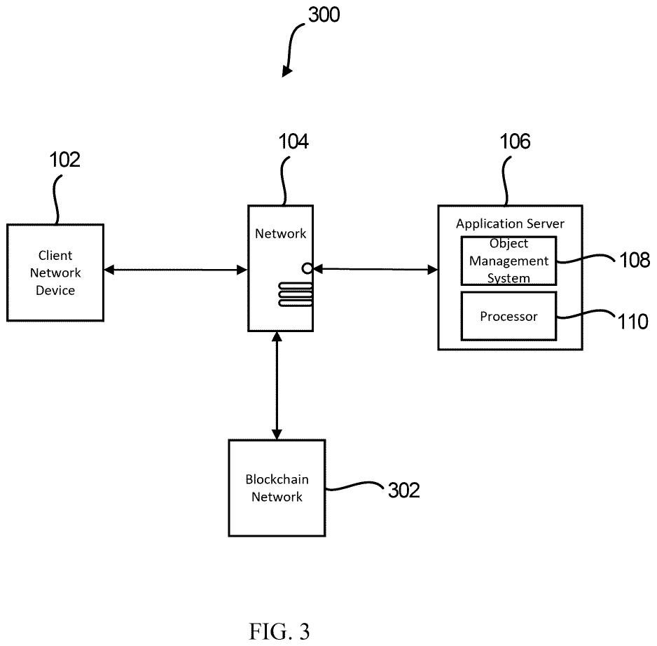

With reference to FIG. 3, a block diagram in accordance with various embodiments of a system 300 is shown. In various embodiments, system 300 comprises all the components of system 100 and a blockchain network 302 connected to the network 104. The blockchain network 302 may be any sort of blockchain network as described throughout this specification to track and securely store data associated with each object submission.

In various embodiments, the blockchain network can comprise a distributed ledger, wherein client network device 102 and application server 106 have access to the distributed ledger and a record of transactions stored thereon. The client network device 102 and the application server 106 cannot change the record of transactions after the record of transactions have been recorded. However, the client network device and application server 106 can record new transactions on the distributed ledger. The new transaction is considered a block of data, and in various embodiments, the block of data can comprise the object and all the object data. The block of data joins other blocks of data stored on the blockchain network 302 to form a chain of data. Each additional block of data strengthens the verification of the previous block of data and hence the entire blockchain. The process renders the blockchain tamper-evident which is a key strength of immutability and removes the possibility of tampering by a malicious actor.

In various embodiments, the blockchain network 302 may receive a transaction from the application server 106, in response to a verification tag being generated by the application server 106. The transaction comprises transaction data, which may comprise object data and account data associated with the user's profile. The application server 106 may sign the transaction, prior to transmitting the transaction to the blockchain network 302. The application server 106 signs the transaction by generating a cryptographic signature using a private key to prove that the transaction is authentic. The use of the signature prevents the private key from being directly published to the blockchain network 302 for privacy and security purposes. In various embodiments, after the application server 106 has signed the transaction, the transaction data includes a transaction string comprising the transaction in a single string (e.g., the cryptographic signature, and object data including latitude and longitude of the client network device 102), and a unique transaction hash used to identify the transaction. Once the application server 106 transmits the signed transaction to the blockchain network 302, then a miner on the blockchain network 302 confirms the signed transaction and creates a block for the transaction. After the block is created, a transaction receipt is transmitted back to the application server 106. In various embodiments, the transaction receipt may comprise the transaction hash and a block hash corresponding to the block.

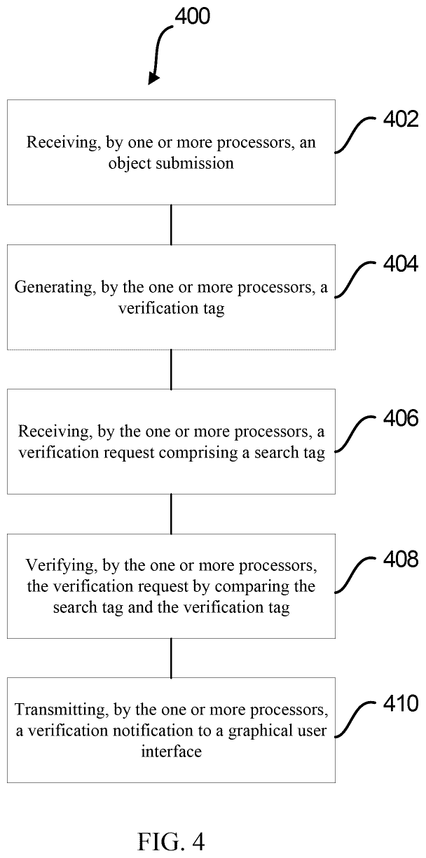

With reference to FIG. 4, a block diagram of a method 400 is shown, in accordance with various embodiments. Both systems 100 and 300 may implement method 400. Method 400 includes receiving, by one or more processors (e.g., one or more processors 110), an object to be verified (step 402). In various embodiments, the object is transmitted from a first network device (e.g., client network device 102). In various embodiments, the method 400 comprises generating, by the one or more processors, a verification tag associated with the object (step 404). Method 400 includes receiving, by the one or more processors, a verification request from a second network device (e.g., a second client network device 102 in communication with the network 104), the verification request comprising a search tag (step 406). In various embodiments, method 400 can comprise verifying, by the one or more processors, the verification request by comparing the search tag and the verification tag (step 408). In various embodiments, method 400 further comprises transmitting, by the one or more processors, a verification notification to a graphical user interface of the second network device in response to the verification request (e.g., client network device 102) (step 410).

With further reference to additional embodiments, another method is described. This method comprises accessing, by a first network device (e.g., client network device 102), a graphical user interface (e.g., GUI 204) of the object management system (e.g., object management system 108), stored on an application server (e.g., application server 106); transmitting, by the first network device, an object submission to the object management system, wherein the object submission comprises an object; generating, by the application server, a verification tag associated with the object; receiving, by the first network device, the verification tag. Both systems 100 and 300 can implement this method.

Existing methods of verification can be unsecure, yet many use cases exist in which physical verification is desired. Some examples where physical verification may be desired include authentication and verification of documents (e.g., birth certificate, passport, car title, etc.), currency, and goods. In various embodiments, the system may include an authentication tag. The authentication tag may take any form and be comprised of any material. For example, the authentication tag may be a flat structure. The flat structure may be about the size of credit-card. The authentication tag may be a safety layer. The safety layer may include any structure. The structure may be an internal structure. The internal structure may be a chaotic 3D structure. The internal structure is unique, so it is almost impossible to replicate and serves as a unique identifier. The structure links the physical authentication tag to a secure digital record (e.g., safety stamp) for use on the platform discussed herein.

The safety layer securely authenticates and/or verifies physical objects by associating with an object of an object submission. In various embodiments, the material can comprise a plastic polymer coating, a silicon glass, and/or any other suitable material. The material comprising the chaotic structure can then be attached to the physical objects being verified. An exemplary embodiment is using the safety layer as a seal-to-seal documents, physical structures or hardware (e.g., bank machines, computers, containers in a supply chain, weapons, products in their packaging, etc.). Another exemplary embodiment is embedding the structure directly into the physical object being verified (e.g., into a tag of a shirt, into a piece of currency, into a passport, tickets for concerts, sports games, train tickets, etc.). In various embodiments, the structure can be embedded into an identification card, which is meant to accompany the physical object and be presented alongside the physical object to show authentication, similar to a serial card presented with luxury timepieces.

In various embodiments, the safety stamp for the physical authentication tag (e.g., safety layer) comprises data associated with the safety layer. The data can comprise owner information (e.g., user's name, user ID, etc.) of the object associated with the safety layer, the registrant's information for whoever registered the safety layer, the device used to register the safety layer, if applicable, a company who manufactured the object associated with the safety layer's information from the company's database (e.g., Enterprise Resource Planning or CMS databases), object identifiers (e.g., color, shape, and size of the object), and/or an ownership log of the object that is modifiable by the current owner in response to the object changing ownership at point of sale or a third-party transaction, and any changes to the object's appearance (e.g., change in color). Further, the safety stamp associated with the safety layer can comprise the manufacturer's name, a production line information, a serial number and/or part number, original features of the object (e.g., size, paint color, etc.), and a location of manufacturer should the manufacturer allow the publication of the location.

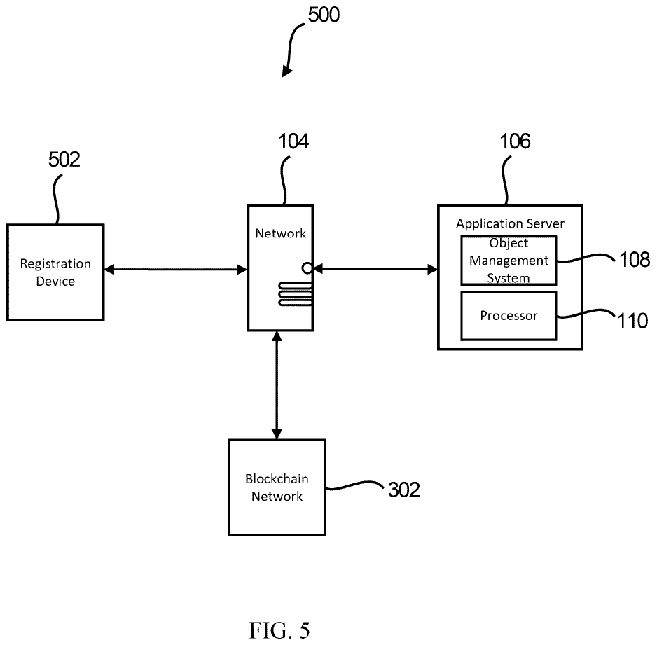

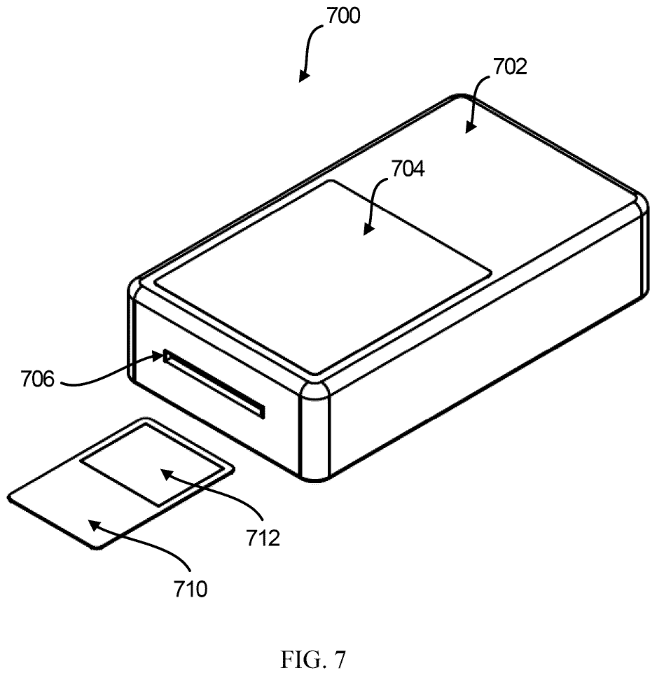

With reference to FIG. 5 and FIG. 7, a block diagram in accordance with various embodiments of a system 500 is shown. In various embodiments, system 500 comprises all the components of systems 100 and/or 300, and a registration device 502 connected to the network 104. The registration device 502 may be any sort of client network device or device as described throughout this specification. In various embodiments, a user utilizes the registration device 502 to register a physical object with the application server 106. In various embodiments, the user registers the physical object using a safety layer and then associates the safety layer with the physical object. In various embodiments, a user logs into his verified account in order to move forward with registering the physical object. In various embodiments, the user accesses his verified account using a human verification device, as part of registering the physical object.

In various embodiments, the registration device 502 is a device 700, which comprises a display 704 for users to view a GUI (e.g., GUI 204) and input object data of a physical object to be registered and stored on the object management system 108. In various embodiments, the object data may comprise, for example, a description of the physical object, an image of the physical object, an owner of the physical object, and/or geolocation data (e.g., a latitude, a longitude, and an altitude) of the registration device 502. In various embodiments, the registration device 502 is connected to the network 104 and is configured to transmit the object data to the application server and/or the blockchain network 302.

In various embodiments, the device 700 comprises a body 702 and a port 706, which is configured to receive a card 710 comprising a material 712. In various embodiments, the body 702 further houses a scanner (e.g., a near-infrared scanner, a laser scanner, a light scanner, a camera, or other known optical device capable of capturing imagery) to scan the material 712. In various embodiments, the material 712 is a plastic polymer material, silicon glass, and/or any other suitable material. The material 712 can comprise a chaotic structure that is unique and used as an identifier with the system 500. A chaotic structure is a physical structure that cannot be duplicated as it has unique characteristics and features that are not reproduceable. In various embodiments, the card 710 can be used to accompany the physical object once it is registered with the system 500. In various embodiments, the registration device 502 is used to acquire and transmit scan data of the chaotic structure of the material 712 and transmit any associated object data of the physical object being verified to the application server 106. In various embodiments, the application server 106 receives the scan data of the chaotic structure, records the scan data of the chaotic structure and the associated object data of the physical object in the object management system 108. The application server 106 generates a verification tag for the chaotic structure. In various embodiments, the verification tag and the scan data of the chaotic structure may be transmitted to the blockchain network 302 and recorded as disclosed herein.

In various embodiments, the scanner described herein can be configured to read attributes of a three-dimensional structure including, for example, configuration, surface topology, depth variations, micro-textures, reflective properties and/or refractive properties (e.g., light scattering patterns). These specific attributes are processed into a digital signature that represents the materials unique configuration. In various embodiments, the digital signature can be created through a process comprising data collection, attribute transformation, feature encoding, normalization, and/or signature construction. For example, the scanner captures a detailed dataset of the structure and the raw data is processed to identify attributes. The identification of attributes may involve analyzing patterns and irregularities that are unique to the material's structure, such as micro-level and macro-level deformations or chaotic distributions. The identified attributes are encoded into mathematical representations. For instance, geometric patterns, spatial relationships, and variations in material properties are translated into numerical or vector data. The vector data is normalized to remove noise or inconsistencies caused by variations in environmental conditions, such as lighting or angles during the scan. This normalization step can help ensure the digital signature remains consistent across different scans. The processed and normalized data is then input into a deterministic algorithm that generates the digital signature. This algorithm combines the encoded features into a compact, unique identifier that reflects the material's intrinsic characteristics. In some embodiments, the resulting digital signature may be further processed using a cryptographic hash function to ensure it is immutable and secure, while also reducing it to a manageable size.

In various embodiments, the chaotic structure of the material is a three-dimensional structure of the material. A three-dimensional chaotic structure offers a level of complexity that cannot be replicated or forged using traditional two-dimensional imaging or printing technologies. By capturing depth and randomness within a three-dimensional space, the system provides a unique identifier for every instance, making counterfeiting virtually impossible. This means that the scanner can capture multiple images of the material and the chaotic structure from different angles. The chaotic structure is fully analyzed by observing it from multiple perspectives, revealing all unique features. A single two-dimensional scan could be forged or simulated; however, a three-dimensional structure requires depth analysis, which makes replication exponentially harder. Further, multi-angle imaging allows for comprehensive verification by comparing how the structure's features align in three-dimensional space with its recorded digital counterpart. Technologies like Near-Infrared (NIR) scanning or stereoscopic imaging (e.g., Laser scan technology, Hyperspectral Imaging, Structured Light Scanning, Polarized Light Scanning, Multi-Spectral Imaging, Photogrammetry) are highly effective for capturing the depth and intricate details of a three-dimensional chaotic structure. However, this process can also be achieved with standard cameras.

By utilizing advanced algorithms, the system can generate a point cloud from multiple two-dimensional images taken from different angles. This point cloud reconstructs the 3D structure and matches it against the database for verification. This approach not only ensures high accuracy in capturing the chaotic structure, but also increases accessibility by allowing users to perform verification with everyday devices (e.g., smartphones or webcams) bridging the gap between specialized hardware and mainstream applications.

In various embodiments, the three-dimensional chaotic structure comprises micro-patterns and macro-patterns. The micro-patterns are fine details that are undetectable to the naked eye, but crucial for machine-based verification. The macro-patterns are larger, visible patterns that provide an initial layer of verification that can be inspected visually or through standard cameras. In various embodiments, the scanning combines multiple scanning modalities for a more robust verification process. The multiple scanning methods can comprise combining one or more of optical scanning (e.g., visible light, near infrared, Laser scan technology, Hyperspectral Imaging, Structured Light Scanning, Polarized Light Scanning, Multi-Spectral Imaging, Photogrammetry), ultrasound, magnetic resonance or holographic imaging. Combining scanning modalities makes forgery of the chaotic structure exponentially more difficult.

In various embodiments, the registration device 502 can be configured to produce the material 712 and a chaotic material embedded in the material (e.g., a three-dimensional chaotic structure), and when the registration device produces the material 712 it also scans the material 712 and transmits the scan data and object data to the application server 106. This can be used for scaling up large manufacturing processes, for example, the registration device 502 could have a printer setup to print the material 712 to be embedded on the physical object during assembly of the physical object. In various embodiments, the material may be partially or fully embedded in or on the physical object (e.g., as a film or seal). For example, the material may be a translucent strip embedded in paper/plastic currency. In various embodiments, the material 712 can be produced off-site and shipped to companies, wherein the companies register the material 712 on-site as associated with the company.

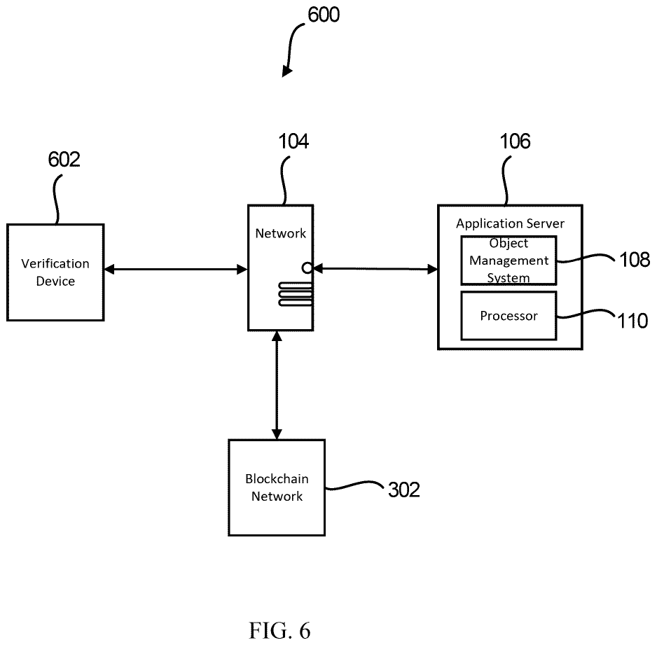

With reference to FIG. 6 and FIG. 7, a block diagram in accordance with various embodiments of a system 600 is shown. In various embodiments, system 600 comprises all or any subset of the components of systems 100, 300 and/or 500, and a verification device 602 connected to the network 104. The verification device 602 may be any sort of client network device or device as described throughout this specification. In various embodiments, the device 700 can be both a registration device 502 and a verification device 602. In various embodiments, a user utilizes the verification device 602 to verify whether a physical object is registered with the application server 106.

In various embodiments, the verification device 602 is a device 700, which comprises a display 704 for users to view a GUI (e.g., GUI 204) and receive object data of the physical object being verified, if the object data is registered and stored on the object management system 108. In various embodiments, the verification device 602 is connected to the network 104 and is configured to receive the object data from the application server and/or the blockchain network 302. In various embodiments, the user looking to verify the physical object can use the verification device 602 to scan a material 712 comprising the chaotic structure and transmit the scan data to the application server 106. The application server 106 searches the object management system 108 for the scan data to determine whether the physical object associated with the scan data has been registered on the application server 106. In various embodiments, if the physical object was registered, the application server 106 transmits a verification notification to the display of the verification device. The notification may include either an unverified statement or a verified statement. If the verification notification is the unverified statement, then the user knows the physical object is not authentic. If the verification notification is the verified statement, then the user knows the physical object is verified. In various embodiments, the verified statement may comprise the object data associated with the scan data.

In various embodiments, if the physical object is changing ownership from one user to another user (e.g., sale of a vehicle, tickets, guns), a change of ownership and new owner information can be updated and saved to the object data for that physical object. This will allow users verifying objects to also see the entire chain of title of the object. For example, buyers on a marketplace (hosted on the application server) may see the chain of title and verify ownership of physical objects before purchase. In various embodiments, a manufacturer of the object can put a hold on the object, so that the object cannot be transacted for a certain period of time, in accordance with an agreement between the buyer and the manufacturer. For example, certain limited Porsche vehicles cannot be resold by a buyer for at least twelve months, and the ownership information for the Porsche on the object management system will not be changed until after twelve months.

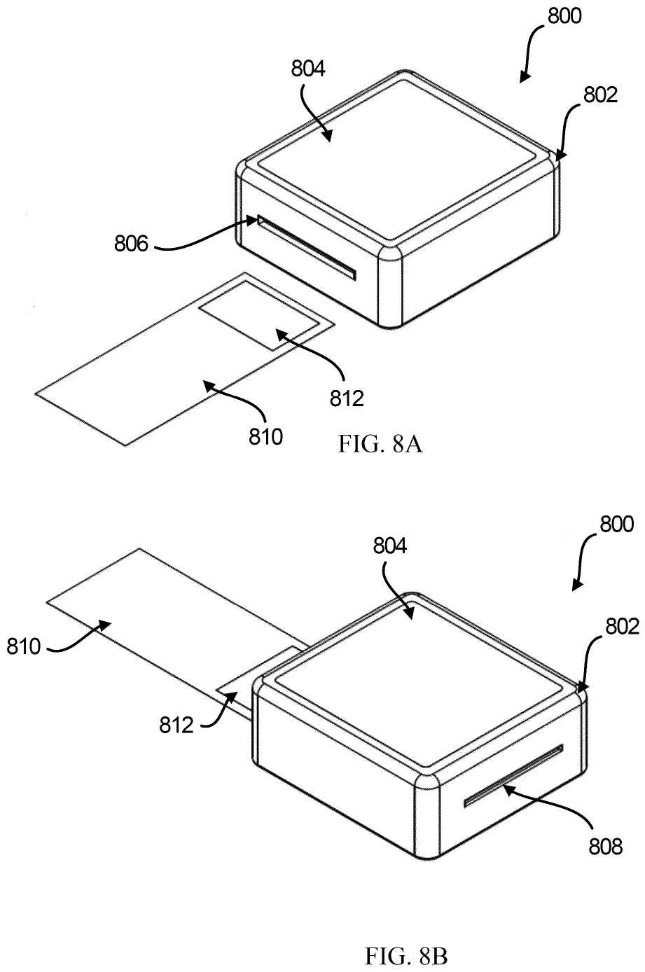

With additional reference to FIG. 8A and FIG. 8B, a device 800 is shown. In various embodiments, the registration device 502 is the device 800, which comprises a display 804 for users to view a GUI (e.g., GUI 204). The users may input object data of a physical object to be registered and stored on the object management system 108. In various embodiments, the device 800 comprises a body 802 and an entry port 806, which is configured to receive a currency 810 comprising a material 812. The associated object data that is sent to the object management system for 810 can comprise a country of origin, a denomination, a print year, and/or any other identifiable information typically used with currency. In various embodiments, the body 802 further houses a scanner (e.g., a near-infrared scanner, a camera, other known device capable of capturing imagery, or any other disclosed device) to scan the material 812. In various embodiments, the material 812 is a plastic polymer material and/or silicon glass. The material 812 can comprise a chaotic structure that is unique and used as an identifier with the system 500. A chaotic structure is a physical structure that cannot be duplicated as it has unique characteristics and features that are not reproduceable and/or too complex to reproduce. Additionally, the device 800 comprises an exit port 808, which outputs the currency 810 once the currency is scanned by the scanner. In various embodiments, the registration device 502 acquires and transmits scan data of the chaotic structure of the material 812. The registration device 502 transmits any associated object data of the physical object being verified to the application server 106. In various embodiments, the application server 106 receives the scan data of the chaotic structure, records the scan data of the chaotic structure and the associated object data of the physical object in the object management system 108. The application server 106 generates a verification tag for the chaotic structure. In various embodiments, the verification tag and the scan data of the chaotic structure may be transmitted to the blockchain network 302 and recorded, as disclosed herein.

In various embodiments, the verification device 602 is the device 800, which comprises the display 804 for users to view a GUI (e.g., GUI 204) and to receive object data of the physical object being verified, if the object data is registered and stored on the object management system 108. In various embodiments, the device 802 is connected to the network 104 and is configured to receive the object data from the application server and/or the blockchain network 302. In various embodiments, the user looking to verify a currency 810 can use the device 800 to scan the material 812 comprising the chaotic structure and transmit the scan data to the application server 106. The application server 106 searches the object management system 108 for the scan data to determine whether the currency associated with the scan data has been registered on the application server 106. In various embodiments, if the currency was registered, the application server 106 transmits a verification notification to the display of the verification device. The notification may include either an unverified statement or a verified statement. If the verification notification is the unverified statement, then the user knows the physical object is not authentic. If the verification notification is the verified statement, then the user knows the physical object is verified. In various embodiments, the verified statement may comprise the object data associated with the scan data.

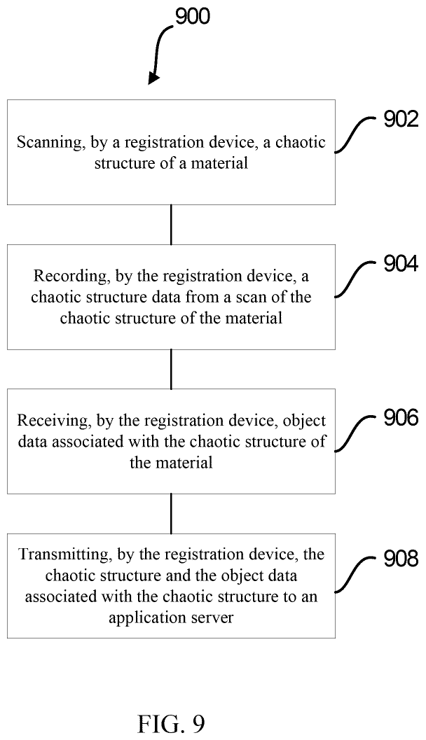

With reference to FIG. 9, a block diagram of a method 900 is shown, in accordance with various embodiments. System 500 may implement method 900. Method 900 includes scanning, by a registration device (e.g., registration device 502), a chaotic structure of a material (step 902). In various embodiments, the chaotic structure is scanned by the registration device and is transmitted to an application server (e.g., application server 106) as chaotic structure data. Method 900 includes recording, by the registration device, chaotic structure data from the scan of the chaotic structure of the material (step 904). Based on the randomness of nature, the chaotic structure data is highly unlikely to be the same as any other chaotic structure data, which makes it almost impossible to reproduce the structure data. In various embodiments, the method 900 comprises receiving, by the registration device, object data associated with the chaotic structure (step 906). In various embodiments, the user registering the physical object enters the object data through a display of the registration device. Method 900 includes transmitting, by the registration device, the chaotic structure data and the object data to the application server (step 908).

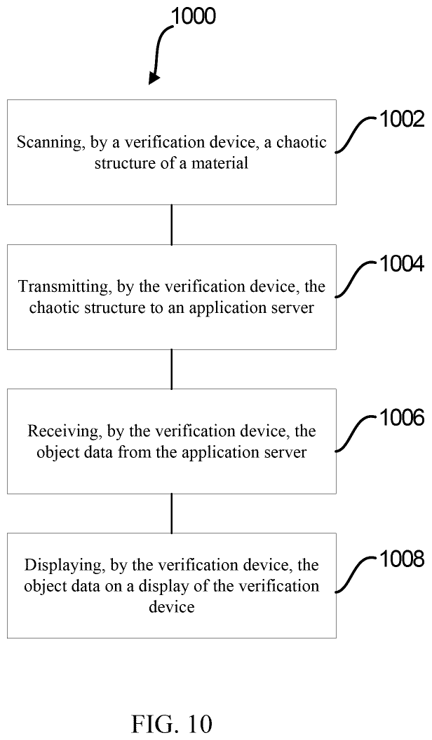

With reference to FIG. 10, a block diagram of a method 1000 is shown, in accordance with various embodiments. System 600 may implement method 1000. Method 1000 includes scanning, by a verification device (e.g., verification device 602), a chaotic structure of a material (step 1002). In various embodiments, the chaotic structure is scanned by the verification device and is transmitted to an application server (e.g., application server 106). In various embodiments, the method 1000 comprises transmitting, by the verification device, scan data associated with the chaotic structure to the application server (step 1004). Method 1000 includes receiving, by the verification device, object data associated with the scan data and stored on the application server, if the scan data of the chaotic structure is registered on the application server (step 1006). In various embodiments, method 1000 can comprise displaying, by the verification device, the object data on a display of the verification device (step 1008).

In various embodiments, the device 700 and device 800 can be a registration device, a verification device, or both, and can implement all of the steps in both methods 900 and 1000.

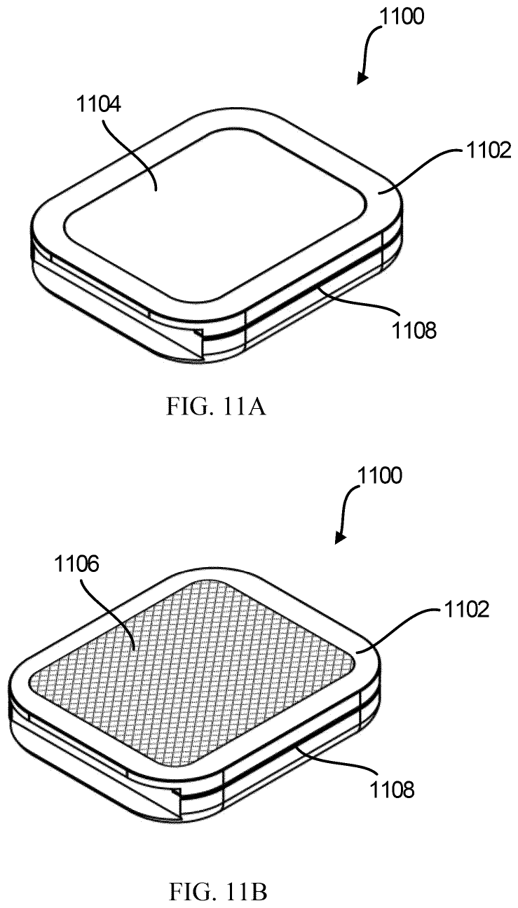

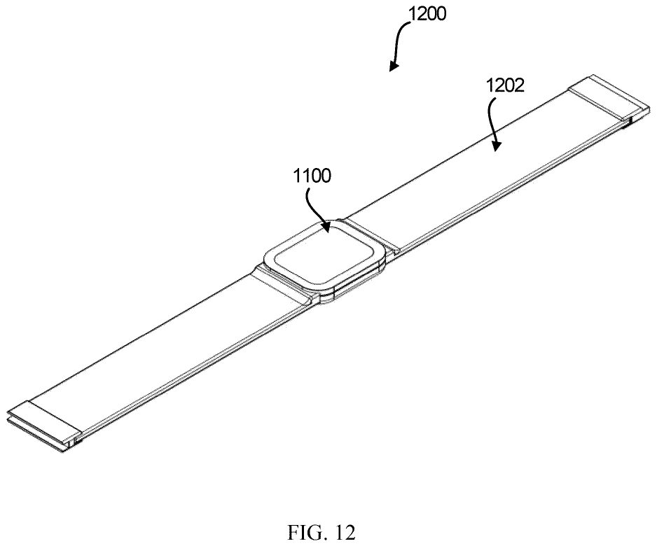

With reference to FIG. 11A, FIG. 11B and FIG. 12, a human verification device 1000 is shown, in accordance with various embodiments. In various embodiments, the human verification device 1100 can be used as a verified form of online assets, such as digital wallets (e.g., online credit/debit cards, gift cards, etc.), and online identification (e.g., state photo identification, and passports, where some jurisdictions have created online forms of these documents). In various embodiments, the human verification device 1100 is a wearable human verification device 1200, comprising a wearable strap 1202 (e.g., a wrist strap, a necklace, a phone case or a wallet), and a device housing 1102 of the human verification device 1100 is connected to the wearable strap 1202. In various embodiments, a chaotic structure on a material 1106 (e.g., the chaotic structures described herein) is disposed within the device housing 1102. In various embodiments, a glass, transparent material or translucent material 1104 (e.g., an electrochromic glass) is disposed in the housing above (and/or in contact with) the top surface of the material 1106.

Electrochromic glass can toggle between states of opaqueness and transparency depending on an electrical current in communication with the electrochromic glass. The use of a restricted surface (e.g., opaque surface) over the material 1106 may help to prevent others from photographing the material 1106 and the restricted surface may reduce a certain amount of ultraviolet light from reaching the material 1106. FIG. 11A shows the human verification device 1100 when the glass 1104 is opaque and FIG. 11B shows the human verification device 1100 when the glass 1104 is transparent and the material 1106 is visible. In various embodiments, a biometric scanner 1108 (e.g., a finger print scanner or a face scanner) is disposed on the exterior of the device housing 1102. In various embodiments, a battery is disposed in the device housing to provide power to the electrochromic glass 1104 and the biometric scanner 1108. The battery can be a long use battery that is activated upon use. The battery may not be replaceable, and upon loss of charge of the battery, the human verification device 1100 is replaced with a new human verification device with a new chaotic structure. In various embodiments, the battery can be recharged through wired and/or wireless charging, or it can be replaced.

In various embodiments, the material 1106 is a human authentication tag. The human authentication tag may take any form and be comprised of any material. For example, the human authentication tag may be a flat structure. The human authentication tag may be a safety key. The safety key may include any structure. The structure may be an internal structure. The internal structure may be a chaotic three-dimensional structure as described herein. The internal structure is unique, so it is challenging to replicate and serves as a unique identifier. The structure links the human authentication tag to a secure digital record (e.g., safety stamp) for use on the platform discussed herein. In various embodiments, in order to register a physical object on the platform, the user verifies his identification by using his human authentication tag with a verification device, prior to registering the physical object. Accordingly, the user's information will be included in the associated object data saved on the object management system for the physical object. In various embodiments, the user information saved on the object management system is personal data comprising a name, a personal photo, and at least one of a method of payment (e.g., credit card, debit card, gift card, etc.), a passport, a driver's license, and/or an ownership ledger. The ownership ledger can comprise a list of all the physical objects and digital objects owned by the user on the object management system. In various embodiments, the safety key is embedded in the human verification device and the human verification device is not connected to any network, making the human verification device fully siloed.

In various embodiments, the safety stamp for the human authentic tag (e.g., safety key) comprises data associated with the safety key. The data can comprise owner information of the safety key, the registrant's information for whoever registered the safety key (including the device used to register the safety key), and a status of the safety key (e.g., active, deactivated/dead, and lost).

A method of using the human verification device is disclosed. In various embodiments, the method comprises a user wearing the human verification device. While the user is wearing the human verification device, the electrochromic glass is opaque or obscured, which prevents the chaotic structure of the material from being seen or scanned. In various embodiments, the user can turn the electrochromic glass transparent by activating the biometric scanner. Once the biometric scanner is activated and the biometric scanner confirms that the user is the one trying to access the chaotic material (e.g., a fingerprint scanned matches the user's fingerprint), then the electrochromic glass turns transparent for any desired period of time. For example, the period of time is between 10 seconds and 30 seconds, or between 5 seconds and 20 seconds. While the chaotic structure is visible, the user can scan the chaotic structure with a verification device, such as the verification devices disclosed herein and/or a camera on a client network device. The verification device verifies, by submitting to the application server, the user's information and any of the payment methods and/or identification associated with the user.

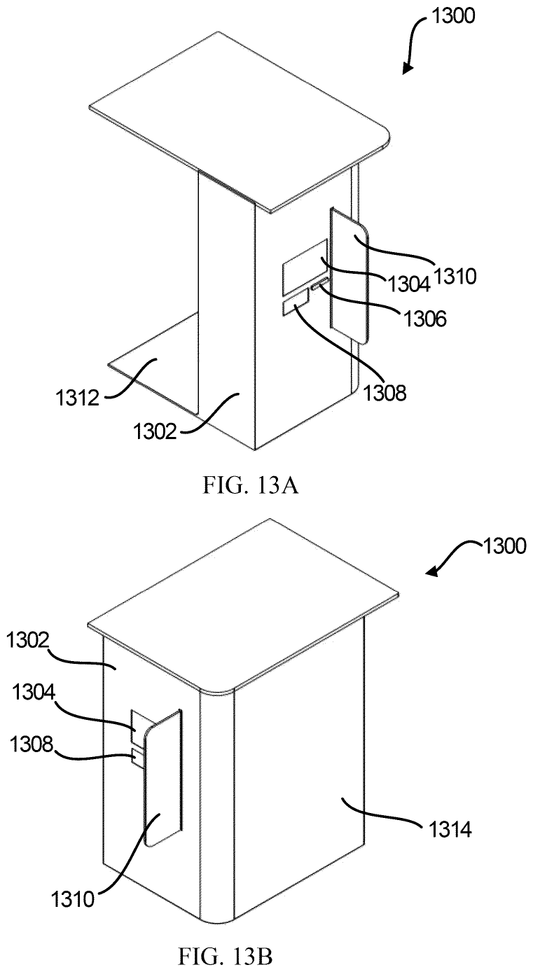

With reference to FIG. 13A and FIG. 13B, a verification terminal 1300 is shown, in accordance with various embodiments. In various embodiments, the verification terminal 1300 can be used to verify human identification, disperse human verification devices and safety keys, verify objects with safety layers and/or any other method of verification described herein or known in the art. In various embodiments, the verification terminal 1300 comprises a housing 1302, a display 1304 disposed in the housing, an embedded scanner device 1306 (e.g., any scanner as described herein or known in the art) disposed in the housing and configured to scan safety layers and/or safety keys, an opening 1308 for disbursement of human verification devices, safety keys, and/or safety layers. For additional privacy and security, the verification terminal 1300 can comprise a privacy shield 1310, which may block outsiders from seeing sensitive information on the display. In various embodiments, the verification terminal 1300 further comprises a semi-enclosed private area 1312, which is partially enclosed by a sidewall 1314. The semi-enclosed private area 1312 can also comprise a surveillance system (e.g., one or more cameras and/or microphones) display, an embedded scanner device, and an opening for disbursement of human verification devices, safety keys, and/or safety layers. In various embodiments, the verification terminal 1300 is connected to a network or can be used offline.

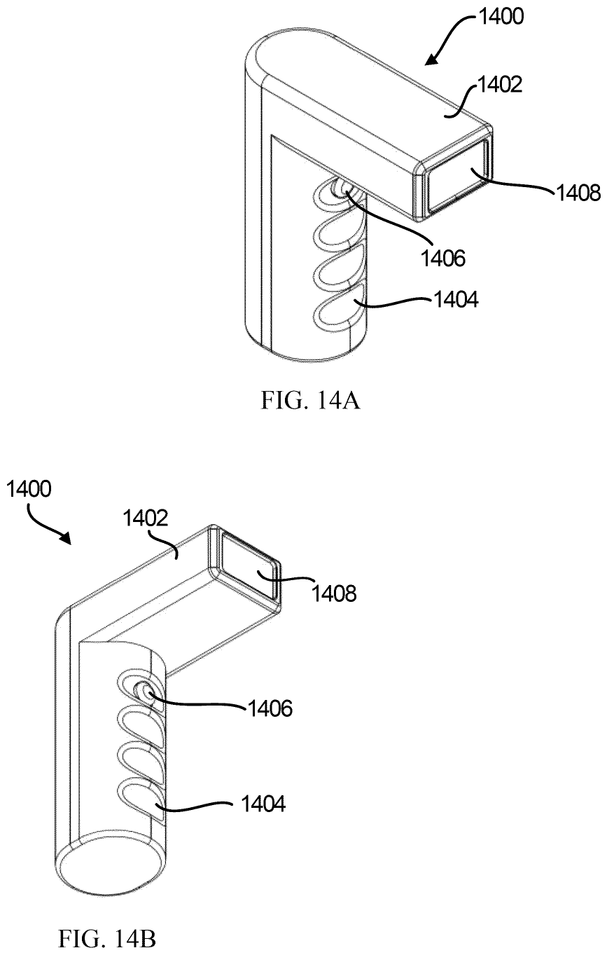

With additional reference to FIG. 14A and FIG. 14B, a handheld reader device 1400 is shown, in accordance with various embodiments. In various embodiments, the handheld reader device 1400 is a registration device as described herein. In various embodiments, the handheld reader device 1400 is configured to scan safety keys and/or safety layers within production/manufacturing environments and/or at point-of-sale locations. In various embodiments, the verification terminal 1300 may comprise, in addition to or in place of the embedded scanner device 1306, one or more of the handheld reader devices 1400. In various embodiments, the handheld reader device 1400 comprises a housing 1402, one or more finger grips 1404, an action button 1406 disposed in one of the one or more finger grips 1404, and/or a scanning window 1408. In various embodiments, the handheld reader device 1400 comprises hardware and network compatibility to scan safety layers and safety keys, while connected to a network or offline while connected to a verification terminal 1300. In various embodiments, the handheld reader device 1400 comprises a scanner (e.g., any scanner as described herein), wherein the scanner is configured to scan through the scanning window to detect and scan a safety layer and/or a safety key. In various embodiments, the handheld reader device 1400 can be used at verification centers and/or anywhere else a registration device or a verification device is desired. In various embodiments, verification centers (e.g., For Safety Center) are locations where people can go to get their first safety key and human verification device, request help from technicians regarding devices and use verification terminals.

In various embodiments, the object management system 108 utilizes machine learning to review objects transmitted by the client network device 102 and help determine if the objects are AI-generated. In various embodiments, this method can be executable computer instructions embodied on at least one non-transitory computer-readable storage medium.

In various embodiments, the object management system 108 comprises a filtering tool that is remote from the user and provides customizable filtering features to each user. The filtering tool may provide customizable filtering by filtering access to the data. The filtering tool may identify data or accounts that communicate with the application server 106 and may associate a verification request with an individual account. The system may include a filter on a local computer and a filter on a server. The filtering tool may identify information or accounts, i.e., verified user accounts, that communicate with the application server 106, and associate a verification request and/or an object submission with the individual account.

In various embodiments, the object management system 108 can track the most used icons from client network device 102 connected to the application server 106 via the network 104. The use may be determined over a period of time by tracking the number of times the icon is selected or how much memory is allocated to the icon. The user may also manually enter which icons are used more often. The object management system 108 can then move and organize the user icons to a position on the GUI 204, for example close to the “start” icon.

In various embodiments, the object management system 108 stores elements from different host websites in the application server 106, then when a user accesses the application server 106, the object management system 108 provides a hybrid webpage that merges content from the different host websites. For example, the application server 106 may store information from a third-party website for third-party verification requests and another host website for verified user accounts transmitting objects. Upon access by a third-party verifier, the claimed invention merges the third-party verified information, and the object and provides a verification tag to access the merged data in the form of web page with third party verification and object data.

Below are examples of various verification methods and systems, in accordance with various embodiments as described herein.

### Example 1

A company interested in verifying its products using a method described herein, may complete a KYB process. The KYB process may request various documents be submitted including, for example, Articles of Incorporation, Articles of Organization, Certificate of Incorporation, Certificate of Good Standing, Employer Identification Number Verification, Proof of Business Address, Authorization from Listed Owner or Board Authorization, or any other business documents used by other jurisdictions across the globe. After reviewing and approving certain documents, the company can receive one or more verification devices, one or more registration devices, unregistered materials and/or safety layers (e.g., a material comprising a chaotic structure as described herein) that can be integrated into and/or added into one or more of the company's products as part of the registration process. After reviewing and not approving certain documents, the company receives a notification explaining why the documents were not KYB verified.

Employees of the company responsible for operating the registration devices may have a safety key. Employees (or any individuals) can obtain a safety key by visiting a verification center (e.g., a safety center) and completing a KYC process. The KYC process may request various documents be submitted including, for example, Proof of Identity, Proof of Address, and/or any other supporting documents. If the individual is under the age of consent in a particular country or region (e.g., 18 years old), then the verification center may request parental consent. If the individual passes the KYC, then a biometric scan is completed at the verification center (e.g., a fingerprint scan, facial scan, and/or iris scan) and the scan is associated with a safety stamp in the system database and/or saved directly to one or more memories on the human verification device. The scan and safety stamp may be linked to a safety key that is dispensed to the individual, the safety key being embedded in the human verification device, as described herein. In various embodiments, this process is completed in a monitored environment (e.g., a private room under 24/7 camera surveillance (e.g., the semi-enclosed private area 1312)). The safety key can be used when completing actions that need to be completed by verified individuals and tracked on the system (e.g., transacting verified objects, registering objects, acting as human verification ID, etc.). Future safety key dispensing to replace previous safety keys can be completed by utilizing the biometric scan data saved on the database and/or on the one or more memories of the human verification device. In this way, an individual does not have to bring their documentation again to the verification center. In other embodiments, the biometric scan data is saved on the memory of the human verification device. The safety key can be scanned at a verification center and the biometric scan data stored on the memory can be transferred to a new human verification device. The verification center can then assemble the new human verification device. After it is complete, the user will receive a fully functional, ready-to-use safety key. No online connection is needed for the transfer and assembly process-only the logging of a new safety key and its connection to the user's identity (safety stamp) may be saved through an online connection. In various embodiments, smaller kiosk style versions of the verification centers (e.g., verification terminals) can be set up at various locations across cities (e.g., at malls, banks, post offices, etc.).

After the company has been KYB verified, the verified company can begin to onboard their employees to allow the employees the ability to register company products with the verification device, if the employees are KYC verified and have a safety key. The onboarding may comprise a consulting firm visiting the company to assist with the onboarding process. The consultants can help integrate the one or more verification/registration devices with the company's Enterprise Resource Platform (ERP) system or a similar platform, ensuring a seamless connection. The integration may include sharing the ERP's production line information, a serial number/part number, original product information (e.g., model and color) and possibly location of production site. Following the integration, a workshop can be conducted to train the company's staff on how to handle the devices and the material effectively.

An employee with a safety key is able to login/use a registration device to register the unregistered materials for use with products. The employee may scan their safety key in order to unlock the registration device and start registering safety layers to be used in or with the company's products.

Additionally, authenticators may authenticate products. The authenticators have a similar onboarding path, but the onboarding may include a workshop that explains how the authentication process works in detail, ensuring the new authenticators understand the procedures and tools involved. After the workshop is completed, the participant may undergo a knowledge test designed to evaluate their ability to identify fake or invalid authentications. Successfully passing this test ensures they are ready to perform their duties as an authenticator and concludes the onboarding process.

### Example 2

Certain steps may be involved with registering a product on the system and adding the product to a marketplace hosted on the system. To register a product and connect it to a safety layer, an employee logs into the device using their safety key. The login process with a safety key may involve two methods: physical logins and online logins. For physical logins, the person is present at a verification center or ATM (e.g., to withdraw money). A human verification device comprising the safety key is used to verify their identity. The process includes a biometric authentication (e.g., placing a finger on a biometric scanner integrated into the human verification device). Once authenticated, an opaque glass layer on the key becomes transparent, revealing the safety key. The safety key is then scanned to complete the verification process. For online logins, the user scans their key using a personal device (e.g., a smartphone). This online process also starts with a biometric scan which converts the glass layer on the human verification device to be transparent. The safety key is scanned using the phone's camera, allowing the user to authenticate themselves and gain access securely. In some examples, a token is generated and stored in the database with the safety key, enabling the creation of Single Sign-On login that allows for seamless access to all of the user's accounts associated with the safety key.

After logged in, the employee scans the chaotic structure of the safety layer using the device. In some instances, this scanning process is automated and integrated with the ERP system. The product is registered by inputting desired data points, some of which can be automatically retrieved from the ERP system. These data points may include connection to person (user-ID or anything similar) and/or the owner (ID), Issuer ID/Connection to the person who has issued the safety layer, registration device which has issued the safety layer, company ID which has issued the product, Production line information, changes on the product (e.g., color can change etc.), and/or event log (e.g., ownership history, verification logs). The collected information is stored on an STS. In the background, AI can verify each safety stamp, the accuracy of the data, detect irregularities, flag any suspicious entries and/or flag any unusual entries. After this verification, the product is successfully connected to the safety layer, and the complete record is saved immutably on a blockchain network. The system can comprise a marketplace to sell the products.

Certain steps may be involved with registering a product on the system and adding the product to a marketplace hosted on the system. To register a product and connect the product to a safety layer, an employee logs into the registration device by scanning their safety key. After logged in, the employee scans the chaotic structure of the safety layer using the registration device. The product can be added to a marketplace hosted on the system. In one example, a buyer wants to purchase a product from a seller. Both the buyer and seller must have a safety key and verify their identities using it. The seller lists the product on the marketplace. After the buyer decides to purchase, the buyer can pay using their payment method saved on the database and linked to their safety key. After the purchase, the seller ships the product to a designated center or mail distribution center, where it can be equipped and registered with a safety layer. In some embodiments the safety layer is applied to secure (e.g., seal) the package of the product prior to sending the package with the product to the buyer. The product is then shipped to the buyer. After receiving it, the buyer has the option to verify the product by checking the safety layer with a verification device. Finally, the ownership transfer is completed online, securely linking the product to the buyer's account.

In exemplary embodiments, there are different ways to sell products using the system: in-store, online, and through franchisees. Franchisees purchase products directly from the company, which involves an ownership transfer. Before this can happen, the franchisee completes the company registration process. After registering, they are authorized to sell products both online and in-store. For in-store sales, a customer can buy a product without ownership transfer, completing the transaction without additional steps. However, if ownership transfer is desired, both the customer and the store employee use a safety key. The safety layer embedded in the product, or shipped as a card with the product, is scanned and linked to both the employee's and the buyer's keys. After this process is completed, the ownership is officially transferred physically and on the system. For age-restricted items like tobacco, additional verification may be desired, which can also include authentication using the safety key. For online sales, customers can choose whether or not to request an ownership transfer, or ownership transfer can be automatic after the safety key is scanned. If no transfer is desired by the buyer, the product is simply shipped to the buyer. If ownership transfer is requested, the buyer uses a safety key, and the transfer process is completed online, linking the product to the buyer's safety key and safety stamp. The product can then be picked up at a designated station or be shipped to their home, where the buyer also has the option to verify the safety layer and the product for additional assurance. In some instances, the product and the safety layer are verified at a verification center, or they can be scanned using a client network device to verify.

In the situation where a product does not have a safety layer or if the safety layer appears to be fake, a user can request a safety layer be created for the product through a safety layer verification process. The safety layer verification process begins when a person visits a verification device, such as a verification center. At the verification device, the safety layer is scanned to check its authenticity. If the product does not have a safety layer, the product can undergo an authentication process to get a safety layer for the product. The authentication process can be completed by utilizing any other authentication process described herein. If the safety layer is present and successfully verified, the device displays an output with the registered data associated with the safety layer and the product.

### Example 3

Occasionally, the human verification device comprising the safety key may run out of power in its battery, preventing the glass layer from transitioning from opaque to transparent, thus keeping the safety key hidden and unusable. If a user needs to replace their safety key due to a dead battery or because it has been lost, they should visit verification center. At the verification center, their fingerprint is matched against the database to verify their identity. The database can be a designated server only accessible by the platform owner, and the designated server may be on the blockchain. If a match is found, a new human verification device and safety key can be issued. The person completes a new KYC process, after which the old human verification device is deactivated. The new human verification device and new safety key are then issued, with the person's fingerprint scanned and linked to the safety key, which is securely connected to their personal information. If, however, the battery on the human verification device is between 1% and 5%, the key can be awakened from a sleep mode for one final scan. This can be completed at the verification center. The person verifies themselves using the human verification device, then authenticates again through the human verification device's fingerprint scanner. The stored fingerprint data is transferred to the new human verification device, which is then issued. During this transfer process, the new safety key is scanned and linked to the new human verification device and the person's identity. All data is securely stored in the system after the process is completed. This process can be performed completely offline by copying the biometric scan data directly from the old human verification device to the new human verification device with the new safety key.

### Example 4

To create a safety stamp and save a digital object in the database associated with the safety stamp, a user logs in to the database using their safety key. The user opens the app on their smartphone and begins with the key login process. After logging in, the digital object is uploaded and enriched with additional data. The system can then screen the digital object and can check the provided data for accuracy or any false or duplicative information. If the data is incorrect, a report is generated detailing why the digital object was rejected. If the digital object is approved, the digital object is securely stored on the database and/or the blockchain network, and a safety stamp is created to finalize the process. Additionally, after logging into the system, users can utilize a client network device (e.g., a smart phone) to capture images, videos, or other digital objects generated through an app or the platform and upload them directly to the database. The captured digital object can then be enriched with additional information such as text or ownership details. Once the captured digital object is ready, a screening process checks the accuracy of the provided data. If the data is verified as correct, a safety stamp is created and securely stored. If the data is incorrect, a report is generated explaining the issues.

In some instances, a user has either uploaded digital objects or sold digital objects through the marketplace. For digital objects uploaded to the database, anyone from outside the system can submit a report. For marketplace transactions, only the buyer can leave a review or submit a report. Each report triggers an investigation process, which can take up to 7 days to complete. Users can receive a maximum number of negative investigations (e.g., three strikes); after that, their account is blocked. In addition to reports, users can also leave reviews. While reviews do not directly contribute to strikes, an accumulation of negative reviews may eventually result in a strike.

### Example 5

Users can send items to be verified and added to the database, as well as given a safety layer. The process of utilizing the authentication service begins with the user accessing the platform via the app or a verification center. The user selects the product category and/or the brand, and provides a detailed description of the object they wish to authenticate. Based on the provided details, a list of qualified authenticators specializing in that specific product type is generated by the database. The user selects an authenticator from the list and prepares the product for shipping. All desired certificates and supporting documents are securely packaged with the object.

The process of verifying the product continues when the authenticator receives the product sent by the user. Upon arrival, the authenticator inspects the package to ensure it is intact and matches the provided description. The authenticator can then examine the product using specialized tools and materials provided. The authenticator checks authenticity indicators such as material quality, brand markings, serial numbers, and/or accompanying certificates. This inspection is conducted following strict guidelines to ensure accuracy and reliability.

If the product is determined to be authentic, the product is registered in the database. A safety layer is applied to the product, linking the safety layer to the user's safety key. This layer ensures traceability and prevents tampering. In this instance, the safety layer may be saved in the database as a re-authenticated product, and any old safety layer for the product may be deleted/deactivated from the database. The authenticator securely packages the product with the applied safety layer and ships the product back to the user. If the product cannot be verified as authentic, the authenticator notifies the user. The user may provide additional documentation for a re-check. If the item remains unverifiable after this second review, the item is returned without authentication. This process is designed to uphold the highest standards of transparency and accuracy, while safeguarding both the customer and the platform's integrity.

### Example 6

In some instances, the verification center may hold currency comprising safety layers layered into the currency (e.g., verified money). The process for withdrawing verified money at a verification center includes the person visiting the terminal and logging in using their safety key. They select the option to withdraw money. If the person chooses to withdraw money, then the system checks whether they have one or more active payment methods (e.g., checking account, savings account, credit card, cryptocurrency wallet, etc.) and how much money is associated with the one or more active payment methods. If they select the withdrawal amount, the cash is dispensed. The transaction is securely recorded on the blockchain with a unique key transaction ID.

### Example 7

One example of how the system and methods described can be used is with verification/production of microchips. The microchip can contain a safety layer on the microchip and/or comes with a safety layer card, which is saved alongside a safety stamp. If the product is being issued to a franchisee, this process can also be supervised for added security. After issued, the safety layer on the microchip and/or the safety layer card are associated with the BIOS on the microchip and/or additional hardware such as, for example, GPS sensors or other sensors used to verify location and time. The microchip can be sold to the customer, who can verify the microchip at the verification center by scanning a safety layer, including the safety layer on the microchip and/or the safety layer card. After verification, the customer inserts the microchip into their computer.

When the computer is turned on, the BIOS runs encryption protocols to periodically check for verification on both the safety layer and the safety layer card. After a period of time, the customer may log in with their safety key and verify the safety layer card and safety layer again on the terminal to maintain compliance and keep the microchip working because microchips that are not compliant may be stopped from working. For companies or individuals purchasing in bulk, the entity completes the KYB process. In cases where the customer has more than 50 or 100 chips, additional inspections and detailed reports may be desired. To prevent fraudulent activity, a fraud detection algorithm is in place, capable of identifying threats and enforcing sanctions. Techniques such as IP address tracking, VPN blockers, and/or shadowed VPN detection are used to enhance security. For bulk purchases, companies can connect multiple layer chips to a single layer for management purposes. Inspections are conducted periodically to ensure proper use and handling of the chips, including documentation of how the chips are being utilized. The detailed description of exemplary embodiments herein makes reference to the accompanying drawings, which show exemplary embodiments by way of illustration and their best mode. While these exemplary embodiments are described in sufficient detail to enable those skilled in the art to practice the disclosures, it should be understood that other embodiments may be realized and that logical, and mechanical changes may be made without departing from the spirit and scope of the disclosures. Thus, the detailed description herein is presented for purposes of illustration only and not of limitation. For example, the steps recited in any of the method or process descriptions may be executed in any order and are not necessarily limited to the order presented. Furthermore, any reference to singular includes plural embodiments, and any reference to more than one component or step may include a singular embodiment or step. Also, any reference to attached, fixed, connected or the like may include permanent, removable, temporary, partial, full and/or any other possible attachment option. Additionally, any reference to without contact (or similar phrases) may also include reduced contact or minimal contact.

### Example 8

As technology continues to advance, organizations are exploring innovative data storage and security solutions beyond traditional blockchain technologies, and in some instances, combined with blockchain technologies. These alternatives aim to address limitations such as scalability, energy consumption, and centralized vulnerabilities, while ensuring robust data integrity and security. Accordingly, there are several ways in which data can be saved and transferred to the database. A user can log in to the database by authenticating their safety key and completing a secure communication using TLS/SSL encryption to access a secure API gateway. After being in the secure API gateway, the user can be introduced to a trusted execution environment (TEE) or secure execution environment (SEE), where data processing and storage can occur on the database. One form of data storage utilized by the database can write once read many (WORM) storage, and additional levels of physical security measures can be implemented (e.g., secured server rooms and hardware protection). WORM storage devices provide a secure, immutable way to store data. After data is written, the data cannot be altered or deleted, making the data highly suitable for use cases requiring audit trails, regulatory compliance, and long-term archival. WORM storage devices are best suited for static data and less efficient for dynamic or frequently updated datasets.

Another form of data storage that can be utilized, and in some cases additional to WORM, is a private distributed ledger technology (DLT). Private DLTs can operates within a restricted, controlled environment, providing the benefits of blockchain—such as immutability and distributed consensus—while addressing privacy and scalability concerns. Transactions and data are verified within a permissioned network, offering enhanced control and security, which supports efficient and scalable operations compared to public blockchain networks. Private DLTS can improve privacy because data is only visible to authorized participants, private DLTS lower energy consumption due to reduced computational requirements, and private DLTS can be customizable for specific organizational needs. There are some risks, such as a risk of centralization and a reduction of public auditability compared to public blockchains.

Additionally, security methods are desired for secure device authentication, cryptographic key generation and data integrity verification. Security can be enhanced by utilizing a unique hardware identifier using physical unclonable functions (PUFs). PUFs leverage inherent physical differences in the manufacturing process of hardware components to generate unique identifiers. These identifiers are non-reproducible, because the identifiers are unique, even for devices of the same model and the physical randomness of each key cannot be cloned, making PUFs ideal for authentication and secure key generation. Further, these are hardware safeguards, so there is reduced susceptibility to software based attacks.

PUFs can be merged with one or more blockchains to enhance security, which goes beyond traditional blockchain or PUF applications. PUFs for authentication, when tied to blockchain networks, offer a robust way to verify unique identities in immutable ledgers. Further, combining blockchain with other security and data storage methods described herein, can help address concerns such as energy efficiency and/or privacy. The combination of PUFs with a scalable, efficient ledger system (e.g., DLT) sets this system apart, as existing systems do not typically focus on privacy, while retaining blockchain immutability, which is a significant market gap, especially in sectors needing both transparency and restricted data visibility (e.g., healthcare, defense). Addressing vulnerabilities proactively and incorporating physical damage resistance adds resilience, which goes beyond current blockchain implementations.

Benefits, other advantages, and solutions to problems have been described herein with regard to specific embodiments. Furthermore, the connecting lines shown in the various figures contained herein are intended to represent exemplary functional relationships, connections and/or physical couplings between the various elements. It should be noted that many alternative or additional functional relationships or physical/electronic connections may be present in a practical system. However, the benefits, advantages, solutions to problems, and any elements that may cause any benefit, advantage, or solution to occur or become more pronounced are not to be construed as critical, required, or essential features or elements of the disclosures.

The scope of the disclosures is accordingly to be limited by nothing other than the appended claims, in which reference to an element in the singular is not intended to mean “one and only one” unless explicitly so stated, but rather “one or more.” Moreover, where a phrase similar to “at least one of A, B, or C” is used in the claims, it is intended that the phrase be interpreted to mean that A alone may be present in an embodiment, B alone may be present in an embodiment, C alone may be present in an embodiment, or that any combination of the elements A, B and C may be present in a single embodiment; for example, A and B, A and C, B and C, or A and B and C. Different cross-hatching is used throughout the figures to denote different parts but not necessarily to denote the same or different materials.

Systems, methods and apparatus are provided herein. In the detailed description herein, references to “one embodiment”, “an embodiment”, “an example embodiment”, etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described. After reading the description, it will be apparent to one skilled in the relevant art(s) how to implement the disclosure in alternative embodiment.

Furthermore, no element, component, or method step in the present disclosure is intended to be dedicated to the public regardless of whether the element, component, or method step is explicitly recited in the claims. No claim element is intended to invoke 35 U.S.C. 112(f) unless the element is expressly recited using the phrase “means for.” As used herein, the terms “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus.

As used herein, “communication” means communication of electronic signals with physical coupling (e.g., “electrical communication” or “electrically coupled”) or without physical coupling and via an electromagnetic field (e.g., “inductive communication” or “inductively coupled” or “inductive coupling”). As used herein, “transmit” may include sending electronic data from one system component to another via electronic communication between the components. Additionally, as used herein, “data” may include encompassing information such as commands, queries, files, data for storage, and the like in digital or any other form.

As used herein, “client network device” any suitable hardware, software, and/or database components capable of sending, receiving, and storing data. For example, a client network device may comprise a personal computer, personal digital assistant, cellular phone, smartphone (e.g., IPHONE®, and/or the like), IoT device, and/or the like. The client network device may comprise an operating system, such as, for example, a WINDOWS® mobile operating system, an ANDROID® operating system, APPLE® IOS®, a LINUX® operating system, and the like. The client network device may also comprise software components installed on the client network device and configured to enable access to various system components. For example, the client network device may comprise a web browser (e.g., MICROSOFT INTERNET EXPLORER®, GOOGLE CHROME®, etc.).

In various embodiments, the system may train a model, obtain results, then use the results to enhance the model. More specifically, in various embodiments, the system may use an expanded data set of past data or a subset of text replies to train a neural network. The expanded training set may be developed by applying mathematical algorithms to the acquired set of data. The neural network may then be trained with the expanded data set using a machine learning algorithm that, for example, may determine if an object is artificial intelligence generated or artificial intelligence altered. The system may also use an iterative training algorithm to re-train with additional data.

The present system or any part(s) or function(s) thereof may be implemented using hardware, software, or a combination thereof and may be implemented in one or more computer systems or other processing systems. The operations may be machine operations or any of the operations may be conducted or enhanced by artificial intelligence (AI) or machine learning. AI may refer generally to the study of agents (e.g., machines, computer-based systems, etc.) that perceive the world around them, form plans, and make decisions to achieve their goals. Foundations of AI include mathematics, logic, philosophy, probability, linguistics, neuroscience, and decision theory. Many fields fall under the umbrella of AI, such as computer vision, robotics, machine learning, and natural language processing. Useful machines for performing the various embodiments include general purpose digital computers or similar devices.

Any databases discussed herein may include relational, hierarchical, graphical, blockchain, object-oriented structure, and/or any other database configurations. Any database may also include a flat file structure wherein data may be stored in a single file in the form of rows and columns, with no structure for indexing and no structural relationships between records. For example, a flat file structure may include a delimited text file, a CSV (comma-separated values) file, and/or any other suitable flat file structure. Common database products that may be used to implement the databases include DB2® by IBM® (Armonk, NY), various database products available from ORACLE® Corporation (Redwood Shores, CA), MICROSOFT ACCESS® or MICROSOFT SQL SERVER® by MICROSOFT® Corporation (Redmond, Washington), MYSQL® by MySQL AB (Uppsala, Sweden), MONGODB®, Redis, Apache Cassandra®, HBASE® by APACHE®, MapR-DB by the MAPR® corporation, or any other suitable database product. Moreover, any database may be organized in any suitable manner, for example, as data tables or lookup tables. Each record may be a single file, a series of files, a linked series of data fields, or any other data structure.

Association of certain data may be accomplished through any desired data association technique such as those known or practiced in the art. For example, the association may be accomplished either manually or automatically. Automatic association techniques may include, for example, a database search, a database merge, GREP, AGREP, SQL, using a key field in the tables to speed searches, sequential searches through all the tables and files, sorting records in the file according to a known order to simplify lookup, and/or the like. The association step may be accomplished by a database merge function, for example, using a “key field” in pre-selected databases or data sectors. Various database tuning steps are contemplated to optimize database performance. For example, frequently used files such as indexes may be placed on separate file systems to reduce In/Out (“I/O”) bottlenecks.

More particularly, a “key field” partitions the database according to the high-level class of objects defined by the key field. For example, certain types of data may be designated as a key field in a plurality of related data tables and the data tables may then be linked on the basis of the type of data in the key field. The data corresponding to the key field in each of the linked data tables is preferably the same or of the same type. However, data tables having similar, though not identical, data in the key fields may also be linked by using AGREP, for example. In accordance with one embodiment, any suitable data storage technique may be utilized to store data without a standard format. Data sets may be stored using any suitable technique, including, for example, storing individual files using an ISO/IEC 7816-4 file structure; implementing a domain whereby a dedicated file is selected that exposes one or more elementary files containing one or more data sets; using data sets stored in individual files using a hierarchical filing system; data sets stored as records in a single file (including compression, SQL accessible, hashed via one or more keys, numeric, alphabetical by first tuple, etc.); data stored as Binary Large Object (BLOB); data stored as ungrouped data elements encoded using ISO/IEC 7816-6 data elements; data stored as ungrouped data elements encoded using ISO/IEC Abstract Syntax Notation (ASN.1) as in ISO/IEC 8824 and 8825; other proprietary techniques that may include fractal compression methods, image compression methods, etc.

In various embodiments, the ability to store a wide variety of information in different formats is facilitated by storing the information as a BLOB. Thus, any binary information can be stored in a storage space associated with a data set. As discussed above, the binary information may be stored in association with the system or external to but affiliated with the system. The BLOB method may store data sets as ungrouped data elements formatted as a block of binary via a fixed memory offset using either fixed storage allocation, circular queue techniques, or best practices with respect to memory management (e.g., paged memory, least recently used, etc.). By using BLOB methods, the ability to store various data sets that have different formats facilitates the storage of data, in the database or associated with the system, by multiple and unrelated owners of the data sets. For example, a first data set which may be stored may be provided by a first party, a second data set which may be stored may be provided by an unrelated second party, and yet a third data set which may be stored may be provided by a third party unrelated to the first and second party. Each of these three exemplary data sets may contain different information that is stored using different data storage formats and/or techniques. Further, each data set may contain subsets of data that also may be distinct from other subsets.

As stated above, in various embodiments, the data can be stored without regard to a common format. However, the data set (e.g., BLOB) may be annotated in a standard manner when provided for manipulating the data in the database or system. The annotation may comprise a short header, trailer, or other appropriate indicator related to each data set that is configured to convey information useful in managing the various data sets. For example, the annotation may be called a “condition header,” “header,” “trailer,” or “status,” herein, and may comprise an indication of the status of the data set or may include an identifier correlated to a specific issuer or owner of the data. In one example, the first three bytes of each data set BLOB may be configured or configurable to indicate the status of that particular data set; e.g., LOADED, INITIALIZED, READY, BLOCKED, REMOVABLE, or DELETED. Subsequent bytes of data may be used to indicate for example, the identity of the issuer, user, transaction/membership account identifier or the like. Each of these condition annotations are further discussed herein.

The data set annotation may also be used for other types of status information as well as various other purposes. For example, the data set annotation may include security information establishing access levels. The access levels may, for example, be configured to permit only certain individuals, levels of employees, companies, or other entities to access data sets, or to permit access to specific data sets based on the transaction, merchant, issuer, user, or the like. Furthermore, the security information may restrict/permit only certain actions, such as accessing, modifying, and/or deleting data sets. In one example, the data set annotation indicates that only the data set owner or the user are permitted to delete a data set, various identified users may be permitted to access the data set for reading, and others are altogether excluded from accessing the data set. However, other access restriction parameters may also be used allowing various entities to access a data set with various permission levels as appropriate.

The data, including the header or trailer, may be received by a client network device configured to add, delete, modify, or augment the data in accordance with the header or trailer. As such, in various embodiments, the header or trailer is not stored on the client network device along with the associated issuer-owned data, but instead the appropriate action may be taken by providing to the user, at the standalone device, the appropriate option for the action to be taken. The system may contemplate a data storage arrangement wherein the header or trailer, or header or trailer history, of the data is stored on the system, device or transaction instrument in relation to the appropriate data. Any database discussed herein may comprise a distributed ledger maintained by a plurality of computing devices (e.g., nodes) over a peer-to-peer network. Each computing device maintains a copy and/or partial copy of the distributed ledger and communicates with one or more other computing devices in the network to validate and write data to the distributed ledger. The distributed ledger may use features and functionality of blockchain technology, including, for example, consensus-based validation, immutability, and cryptographically chained blocks of data. The blockchain may comprise a ledger of interconnected blocks containing data. The blockchain may provide enhanced security because each block may hold individual transactions and the results of any blockchain executables. Each block may link to the previous block and may include a timestamp. Blocks may be linked because each block may include the hash of the prior block in the blockchain. The linked blocks form a chain, with only one successor block allowed to link to one other predecessor block for a single chain. Forks may be possible where divergent chains are established from a previously uniform blockchain, though typically only one of the divergent chains will be maintained as the consensus chain. In various embodiments, the blockchain may implement smart contracts that enforce data workflows in a decentralized manner. The system may also include applications deployed on user devices such as, for example, computers, tablets, smartphones, Internet of Things devices (“IoT” devices), etc. The applications may communicate with the blockchain (e.g., directly or via a blockchain node) to transmit and retrieve data. In various embodiments, a governing organization or consortium may control access to data stored on the blockchain. Registration with the managing organization(s) may enable participation in the blockchain network.

Data transfers performed through the blockchain-based system may propagate to the connected peers within the blockchain network within a duration that may be determined by the block creation time of the specific blockchain technology implemented. For example, on an ETHEREUM®-based network, a new data entry may become available within about 13-20 seconds as of the writing. On a HYPERLEDGER® Fabric 1.0 based platform, the duration is driven by the specific consensus algorithm that is chosen, and may be performed within seconds. In that respect, propagation times in the system may be improved compared to existing systems, and implementation costs and time to market may also be drastically reduced. The system also offers increased security at least partially due to the immutable nature of data that is stored in the blockchain, reducing the probability of tampering with various data inputs and outputs. Moreover, the system may also offer increased security of data by performing cryptographic processes on the data prior to storing the data on the blockchain. Therefore, by transmitting, storing, and accessing data using the system described herein, the security of the data is improved, which decreases the risk of the computer or network from being compromised.

In various embodiments, the system may also reduce database synchronization errors by providing a common data structure, thus at least partially improving the integrity of stored data. The system also offers increased reliability and fault tolerance over traditional databases (e.g., relational databases, distributed databases, etc.) as each node operates with a full copy of the stored data, thus at least partially reducing downtime due to localized network outages and hardware failures. The system may also increase the reliability of data transfers in a network environment having reliable and unreliable peers, as each node broadcasts messages to all connected peers, and, as each block comprises a link to a previous block, a node may quickly detect a missing block and propagate a request for the missing block to the other nodes in the blockchain network.

The particular blockchain implementation described herein provides improvements over technology by using a decentralized database and improved processing environments. In particular, the blockchain implementation improves computer performance by, for example, leveraging decentralized resources (e.g., lower latency). The distributed computational resources improve computer performance by, for example, reducing processing times. Furthermore, the distributed computational resources improve computer performance by improving security using, for example, cryptographic protocols.

One skilled in the art will also appreciate that, for security reasons, any databases, systems, devices, servers, or other components of the system may consist of any combination thereof at a single location or at multiple locations, wherein each database or system includes any of various suitable security features, such as firewalls, access codes, encryption, decryption, compression, decompression, and/or the like.

Practitioners will also appreciate that there are a number of methods for displaying data within a browser-based document. Data may be represented as standard text or within a fixed list, scrollable list, drop-down list, editable text field, fixed text field, pop-up window, and the like. Likewise, there are a number of methods available for modifying data in a web page such as, for example, free text entry using a keyboard, selection of menu items, check boxes, option boxes, and the like.

The data may be big data that is processed by a distributed computing cluster. The distributed computing cluster may be, for example, a HADOOP® software cluster configured to process and store big data sets with some of nodes comprising a distributed storage system and some of nodes comprising a distributed processing system. In that regard, distributed computing cluster may be configured to support a HADOOP® software distributed file system (HDFS) as specified by the Apache Software Foundation at www.hadoop.apache.org/docs.

As used herein, the term “network” includes any cloud, cloud computing system, or electronic communications system or method which incorporates hardware and/or software components. Communication among the parties may be accomplished through any suitable communication channels, such as, for example, a telephone network, an extranet, an intranet, internet, client network device, online communications, satellite communications, off-line communications, wireless communications, transponder communications, local area network (LAN), wide area network (WAN), virtual private network (VPN), networked or linked devices, keyboard, mouse, and/or any suitable communication or data input modality. Moreover, although the system is frequently described herein as being implemented with TCP/IP communications protocols, the system may also be implemented using IPX, APPLETALK® program, IP-6, NetBIOS, OSI, any tunneling protocol (e.g., IPsec, SSH, etc.), or any number of existing or future protocols. If the network is in the nature of a public network, such as the internet, it may be advantageous to presume the network to be insecure and open to eavesdroppers. Specific information related to the protocols, standards, and application software utilized in connection with the internet is generally known to those skilled in the art and, as such, need not be detailed herein.

“Cloud” or “Cloud computing” includes a model for enabling convenient, on-demand network access to a shared pool of configurable computing resources (e.g., networks, servers, storage, applications, and services) that can be rapidly provisioned and released with minimal management effort or service provider interaction. Cloud computing may include location-independent computing, whereby shared servers provide resources, software, and data to computers and other devices on demand.

Computer programs (also referred to as computer control logic) are stored in main memory and/or secondary memory. Computer programs may also be received via communications interface. Such computer programs, when executed, enable the computer system to perform the features as discussed herein. In particular, the computer programs, when executed, enable the processor to perform the features of various embodiments. Accordingly, such computer programs represent controllers of the computer system.

These computer program instructions may be loaded onto a general purpose computer, special purpose computer, or other programmable data processing apparatus to produce a machine, such that the instructions that execute on the computer or other programmable data processing apparatus create means for implementing the functions specified in the flowchart block or blocks. These computer program instructions may also be stored in a computer-readable memory that can direct a computer or other programmable data processing apparatus to function in a particular manner, such that the instructions stored in the computer-readable memory produce an article of manufacture including instruction means which implement the function specified in the flowchart block or blocks. The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide steps for implementing the functions specified in the flowchart block or blocks.

In various embodiments, software may be stored in a computer program product and loaded into a computer system using a removable storage drive, hard disk drive, or communications interface. The control logic (software), when executed by the processor, causes the processor to perform the functions of various embodiments as described herein. In various embodiments, hardware components may take the form of application specific integrated circuits (ASICs). Implementation of the hardware so as to perform the functions described herein will be apparent to persons skilled in the relevant art(s).

As will be appreciated by one of ordinary skill in the art, the system may be embodied as a customization of an existing system, an add-on product, a processing apparatus executing upgraded software, a stand-alone system, a distributed system, a method, a data processing system, a device for data processing, and/or a computer program product. Accordingly, any portion of the system or a module may take the form of a processing apparatus executing code, an internet based embodiment, an entirely hardware embodiment, or an embodiment combining aspects of the internet, software, and hardware. Furthermore, the system may take the form of a computer program product on a computer-readable storage medium having computer-readable program code means embodied in the storage medium. Any suitable computer-readable storage medium may be utilized, including hard disks, CD-ROM, BLU-RAY DISC®, optical storage devices, magnetic storage devices, and/or the like.

In various embodiments, components, modules, and/or engines of system 100 may be implemented as micro-applications or micro-apps. Micro-apps are typically deployed in the context of a mobile operating system, including for example, a WINDOWS® mobile operating system, an ANDROID® operating system, an APPLE® iOS operating system, a BLACKBERRY® company's operating system, and the like. The micro-app may be configured to leverage the resources of the larger operating system and associated hardware via a set of predetermined rules which govern the operations of various operating systems and hardware resources. For example, where a micro-app desires to communicate with a device or network other than the mobile device or mobile operating system, the micro-app may leverage the communication protocol of the operating system and associated device hardware under the predetermined rules of the mobile operating system. Moreover, where the micro-app desires an input from a user, the micro-app may be configured to request a response from the operating system which monitors various hardware components and then communicates a detected input from the hardware to the micro-app.

The system and methods are described herein with reference block diagrams and flowchart illustrations of methods, apparatus, and computer program products according to various embodiments. It will be understood that each functional block of the block diagrams and the flowchart illustrations, and combinations of functional blocks in the block diagrams and flowchart illustrations, respectively, can be implemented by computer program instructions.

Accordingly, functional blocks of the block diagrams and flowchart illustrations support combinations of means for performing the specified functions, combinations of steps for performing the specified functions, and program instruction means for performing the specified functions. It will also be understood that each functional block of the block diagrams and flowchart illustrations, and combinations of functional blocks in the block diagrams and flowchart illustrations, can be implemented by either special purpose hardware-based computer systems which perform the specified functions or steps, or suitable combinations of special purpose hardware and computer instructions. Further, illustrations of the process flows, and the descriptions thereof may make reference to user WINDOWS® applications, webpages, websites, web forms, prompts, etc. Practitioners will appreciate that the illustrated steps described herein may comprise, in any number of configurations, including the use of WINDOWS® applications, webpages, web forms, popup WINDOWS® applications, prompts, and the like. It should be further appreciated that the multiple steps as illustrated and described may be combined into single webpages and/or WINDOWS® applications but have been expanded for the sake of simplicity. In other cases, steps illustrated and described as single process steps may be separated into multiple webpages and/or WINDOWS® applications but have been combined for simplicity.

In various embodiments, the software elements of the system may also be implemented using a JAVASCRIPT® run-time environment configured to execute JAVASCRIPT® code outside of a web browser. For example, the software elements of the system may also be implemented using NODE.JS® components. NODE.JS® programs may implement several modules to handle various core functionalities. For example, a package management module, such as NPM®, may be implemented as an open source library to aid in organizing the installation and management of third-party NODE.JS® programs. NODE.JS® programs may also implement a process manager, such as, for example, Parallel Multithreaded Machine (“PM2”); a resource and performance monitoring tool, such as, for example, Node Application Metrics (“appmetrics”); a library module for building user interfaces, and/or any other suitable and/or desired module.

Middleware may include any hardware and/or software suitably configured to facilitate communications and/or process transactions between disparate computing systems. Middleware components are commercially available and known in the art. Middleware may be implemented through commercially available hardware and/or software, through custom hardware and/or software components, or through a combination thereof. Middleware may reside in a variety of configurations and may exist as a standalone system or may be a software component residing on the internet server. Middleware may be configured to process transactions between the various components of an application server and any number of internal or external systems for any of the purposes disclosed herein. WEBSPHERE® MQTM (formerly MQSeries) by IBM®, Inc. (Armonk, NY) is an example of a commercially available middleware product. An Enterprise Service Bus (“ESB”) application is another example of middleware.

The computers discussed herein may provide a suitable website or other internet-based graphical user interface (GUI) which is accessible by users. In one embodiment, MICROSOFT® company's Internet Information Services (IIS), Transaction Server (MTS) service, and an SQL SERVER® database, are used in conjunction with MICROSOFT® operating systems, WINDOWS NT® web server software, SQL SERVER® database, and MICROSOFT® Commerce Server. Additionally, components such as ACCESS® software, SQL SERVER® database, ORACLE® software, SYBASE® software, INFORMIX® software, MYSQL® software, INTERBASE® software, etc., may be used to provide an Active Data Object (ADO) compliant database management system. In one embodiment, the APACHE® web server is used in conjunction with a LINUX® operating system, a MYSQL® database, and PERL®, PHP, Ruby, and/or PYTHON® programming languages.

The system and method may be described herein in terms of functional block components, screen shots, optional selections, and various processing steps. It should be appreciated that such functional blocks may be realized by any number of hardware and/or software components configured to perform the specified functions. For example, the system may employ various integrated circuit components, e.g., memory elements, processing elements, logic elements, look-up tables, and the like, which may carry out a variety of functions under the control of one or more microprocessors or other control devices. Similarly, the software elements of the system may be implemented with any programming or scripting language such as C, C++, C#, JAVA®, JAVASCRIPT®, JAVASCRIPT® Object Notation (JSON), VBScript, Macromedia COLD FUSION, COBOL, MICROSOFT® company's Active Server Pages, assembly, PERL®, PHP, awk, PYTHON®, Visual Basic, SQL Stored Procedures, PL/SQL, any UNIX® shell script, and extensible markup language (XML) with the various algorithms being implemented with any combination of data structures, objects, processes, routines or other programming elements. Further, it should be noted that the system may employ any number of conventional techniques for data transmission, signaling, data processing, network control, and the like. Still further, the system could be used to detect or prevent security issues with a client-side scripting language, such as JAVASCRIPT®, VBScript, or the like.

For the sake of brevity, conventional data networking, application development, and other functional aspects of the systems (and components of the individual operating components of the systems) may not be described in detail herein. Furthermore, the connecting lines shown in the various figures contained herein are intended to represent exemplary functional relationships and/or physical couplings between the various elements. It should be noted that many alternative or additional functional relationships or physical connections may be present in a practical system.

Computer-based system program instructions and/or processor instructions may be loaded onto a tangible, non-transitory computer readable medium having instructions stored thereon that, in response to execution by a processor, cause the processor to perform various operations. The term “non-transitory” is to be understood to remove only propagating transitory signals per se from the claim scope and does not relinquish rights to all standard machine-readable media that are not only propagating transitory signals per se. Stated another way, the meaning of the term “non-transitory machine-readable medium” and “non-transitory machine-readable storage medium” should be construed to exclude only those types of transitory machine-readable media which were found in In re Nuijten to fall outside the scope of patentable subject matter under 35 U.S.C. § 101.

1. A method of verification comprising:
receiving, by one or more processors, an object submission from a first network device, wherein the object submission comprises an object to be verified;
generating, by the one or more processors, a verification tag associated with the object;
receiving, by the one or more processors, a verification request from a second network device, the verification request comprising a search tag;
transmitting, by the one or more processors, a verification notification to a graphical user interface of the second network device, in response to the verification request.

2. The method of claim 1, wherein the object comprises a digital object.

3. The method of claim 1, wherein the object comprises a physical object.

4. The method of claim 1, wherein the verification tag is stored on a blockchain network in communication with the one or more processors.

5. The method of claim 1, wherein the verification tag comprises a latitude, a longitude, an altitude, a time, and a unique number.

6. The method of claim 1, further comprising verifying, by the one or more processors, the verification request by comparing the search tag and the verification tag.

7. The method of claim 1, wherein the verification request comprises a search file.

8. The method of claim 7, further comprising verifying, by the one or more processors, the verification request by comparing the search file and the object.

9. The method of claim 8, further comprising determining, by the one or mor processors, a confidence level of the comparison between the search file and the object.

10. The method of claim 9, wherein the verification notification comprises the confidence level.

11. A system comprising:
one or more processors; and
one or more tangible, non-transitory memories configured to communicate with the one or more processors,
the one or more tangible, non-transitory memories having instructions stored thereon that, in response to execution by the one or more processors, cause the one or more processors to perform operations comprising:
receiving, by the one or more processors, an object submission;
generating, by the one or more processors, a verification tag in response to the object submission;
receiving, by the one or more processors, a verification request comprising a search tag;
determining, by the one or more processors, a verification notification based on the verification request; and
transmitting, by the one or more processors, the verification notification to a graphical user interface of a network device in communication with the one or more processors.

12. The system of claim 11, wherein the object submission comprises an object to be verified, wherein the object is a digital object.

13. The system of claim 11, wherein the object submission comprises an object to be verified, wherein the object is a physical object.

14. The system of claim 11, wherein the verification tag is stored on a blockchain network in communication with the one or more processors.

15. The system of claim 11, wherein the verification tag comprises a latitude, a longitude, an altitude, a time, and a unique number.

16. The system of claim 11, further comprising verifying, by the one or more processors, the verification request by comparing a search file and the object submission.

17. The system of claim 11, further comprising the network device, wherein the network device comprises at least one of a camera and a microphone.

18. The system of claim 17, wherein the network device is configured to transmit a live verified object to the one or more processors from at least one of the camera and the microphone, wherein the one or more processors generates the verification tag for the live verified object.

19. An article of manufacture including one or more non-transitory, tangible computer readable storage mediums having instructions stored thereon that, in response to execution by one or more processors, cause the one or more processors to perform operations comprising:
receiving, by the one or more processors, an object submission;
generating, by the one or more processors, a verification tag in response to the object submission;
receiving, by the one or more processors, a verification request comprising a search tag;
determining, by the one or more processors, a verification notification based on the verification request; and
transmitting, by the one or more processors, the verification notification to a graphical user interface of a network device in communication with the one or more processors.

20. The article of manufacture of claim 19, wherein the object submission comprises an object to be verified, wherein the object is a digital object.
